(19) United States
(12) Patent Application Publication
(10) Pub. No.: US 2010/0069091 A1
(43) Pub. Date: Mar. 18, 2010

(54) MULTI-USERS/MULTI-SERVICES PAGING FOR LOCATION BASED SERVICES

(75) Inventor: Mohamed A. El-Saidny, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/211,010

(22) Filed: Sep. 15, 2008

(51) Int. Cl. H04W 4/02

(52) U.S. Cl. 455/456.3

(57) ABSTRACT

A paging technique for location-based services is provided to improve the paging resources of networks. Aspects relate to a multi-users/multi-services page that enables a multitude of users in a location area to, at substantially the same time, receive a single paging message for several location-based services. The disclosed aspects enable point-of-multi-services-broadcast to/from multiple-point-with-multi-services-decoding. A mobile device can decode the broadcast messages in connected/dedicated mode carried on the shared channels after successfully decoding the broadcast paging indicator portion of the paging changes. Multiple shared channels in connected modes can be transmitted, each carrying a different set of services.

### BACKGROUND

I. Field

The following description relates generally to wireless communication systems and more particularly to paging one or more location based services to multiple users at substantially the same time.

II. Background

Wireless communication systems are widely deployed to provide various types of communication and to transfer information regardless of where a user is located (e.g., inside or outside a structure) and whether a user is stationary or moving (e.g., in a vehicle, walking). For example, voice, data, video and so forth can be provided through wireless communication systems.

Wireless communication systems include multiple-access systems capable of supporting communication with multiple users by sharing available system resources (e.g., bandwidth, transmit power, and so on). Examples, of multiple-access systems include code division multiple access (CDMA) systems, time division multiple access (TDMA) systems, frequency division multiple access (FDMA) systems, 3GPP Long Term Evolution (LTE) systems, orthogonal frequency division multiple access (OFDMA) systems, and others.

Wireless communication networks are established through a mobile device communicating with a base station or access point. The access point covers a geographic range or cell and, as the mobile device is operated, the mobile device can be moved in and out of these geographic cells. A wireless multiple-access communication system can simultaneously support communication for multiple mobile devices. Each device communicates with one or more base stations through transmissions on the forward and reverse links. The forward link (or downlink) refers to the communication from the base stations to the mobile devices and the reverse link (or uplink) refers to the communication link from the mobile devices to the base stations. The communication links can be established through a single-in-single-out (SISO), multiple-in-single-out (MISO), or a multiple-in-multiple-out (MIMO) system.

Mobile location-based services are gaining popularity among users and service providers. Location-based services include transferring information to devices within a particular geographic area. These location-based services can be utilized to deliver emergency, advertising, traffic alerts, and other information. Through utilization of traditional location-based services, a network (e.g., base station) is only capable of sending a single message to each mobile device (e.g., user) at a time to initiate a transfer for a single service. For example, if an emergency message and an advertisement are to be sent at substantially the same time, the two messages (emergency and advertisement) are sent simultaneously in two different occasions. This is inefficient and wastes system resources in addition to wasted power resources on a user device due to the extra wake up periods needed for decoding each service.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect relates to a method for transmitting a location based-services page to a plurality of users. The method includes assigning to a first mobile device a Primary Temporary Mobile Station Identity (Pr-TMSI) that comprises a device identifier and a Service Group (SG). The method also includes transmitting to a plurality of mobile devices that include the first mobile device a broadcast services page message that includes a first Broadcast TMSI (B-TMSI). The B-TMSI comprises retransmission status bits and a group of services offered by a network. The method further includes receiving from the first mobile device a first secondary TMSI (S-TMSI) that includes the device identifier and an indication of one service that is under negotiation from the group of services. Also, the method includes exchanging layer three signaling messages with the first mobile device to convey the one service that is under negotiation.

Another aspect relates to a wireless communications apparatus comprising a memory and a processor. The memory retains instructions related to assigning to a first mobile device a Primary Temporary Mobile Station Identity (Pr-TMSI) that comprises a device identifier and a Service Group (SG). The memory also retains instructions related to transmitting to a plurality of mobile devices a broadcast services page message that includes a first Broadcast TMSI (B-TMSI). The B-TMSI comprises retransmission status bits and a group of services offered by a network. Also, the memory retains instructions related to receiving from the first mobile device a first secondary TMSI (S-TMSI) that includes the device identifier and an indication of one service that is under negotiation from the group of services. Additionally, the memory retains instructions related to exchanging layer three signaling messages with the first mobile device to convey the one service that is under negotiation. The plurality of mobile devices include the first mobile device. The processor is coupled to the memory and is configured to execute the instructions retained in the memory.

A further aspect relates to a wireless communications apparatus that transmits a location based-services page. The apparatus includes means for providing to a first mobile device a Primary Temporary Mobile Station Identity (Pr-TMSI) that comprises a device identifier and a Service Group (SG). Also included is means for conveying to a plurality of mobile devices that include the first mobile device a broadcast services page message that includes a first Broadcast TMSI (B-TMSI). The B-TMSI comprises retransmission status bits and a group of services offered by a network. The retransmission status bits indicate whether the page message is a new transmission or a retransmission. The apparatus also includes means for obtaining from the first mobile device a first secondary TMSI (S-TMSI) that includes the device identifier and an indication of one service that is under negotiation from the group of services. Also included is means for exchanging layer three signaling messages with the first mobile device to convey the one service that is under negotiation.

Yet another aspect relates to a computer program product comprising a computer-readable medium. The computer-readable medium includes a first set of codes for causing a computer to provide to a first mobile device a Primary Temporary Mobile Station Identity (Pr-TMSI) that comprises a device identifier and a Service Group (SG). The computer-readable medium also includes a second set of codes for causing the computer to convey to a plurality of mobile devices that include the first mobile device a broadcast services page message that includes a first Broadcast TMSI (B-TMSI). The B-TMSI comprises retransmission status bits and a group of services offered by a network. Also included in the computer-readable medium is a third set of codes for causing the computer to obtain from the first mobile device a first secondary TMSI (S-TMSI) that includes the device identifier and an indication of one service that is under negotiation from the group of services. Further, the computer-readable medium includes a fourth set of codes for causing the computer to exchange layer three signaling messages with the first mobile device to convey the one service that is under negotiation.

A further aspect relates to at least one processor configured to transmit a location based-services page to a plurality of users. The processor includes a first module for assigning to a first mobile device a Primary Temporary Mobile Station Identity (Pr-TMSI) that comprises a device identifier and a Service Group (SG) and a second module for utilizing a Paging Indicator Channel (PICH) to distinguish between at least two types of pages. The Paging Indicator Channel (PICH) includes Broadcast Paging Indicator (B-PI) bits that are set to “1” for a broadcast message. Also included in the processor is a third module for transmitting to a plurality of mobile devices that include the first mobile device a broadcast services page message that includes a first Broadcast TMSI (B-TMSI). The B-TMSI comprises retransmission status bits and a group of services offered by a network. Also included are a fourth module for receiving from the first mobile device a first secondary TMSI (S-TMSI) that includes the device identifier and an indication of one service that is under negotiation from the group of services and a fifth module for exchanging layer three signaling messages with the first mobile device to convey the one service that is under negotiation.

Another aspect relates to a method for receiving a multiple location based-services page transmitted to a plurality of users. The method includes retaining a Primary Temporary Mobile Station Identity (Pr-TMSI) and detecting energy on a Broadcast Paging Indicator (B-PI). The energy indicates a page message. The method also includes decoding a Broadcast TMSI (B-TMSI) included in the page message. The B-TMSI comprises retransmission status bits and a group of services that indicates one or more services are available. Further, the method includes ascertaining a Primary Services Group (Pr-SG) as a function of a first portion of the Pr-TMSI and services enabled. The method also includes iteratively determining a secondary Services Group (S-SG) as a function of the Pr-SG, the group of services, the retransmission status bits, and a highest priority service received for a first time. The S-SG is initially set equal to Pr-SG. The method also includes conveying a Secondary TMSI (S-TMSI) that includes the S-SG and an identifier of one service included in the S-SG, establishing a layer three signaling connection, and exchanging messages related to the one service identified in the S-TMSI.

A further aspect relates to a wireless communications apparatus that includes a memory and a processor. The memory retains instructions related to retaining a Primary Temporary Mobile Station Identity (Pr-TMSI) and detecting energy on a Broadcast Paging Indicator (B-PI). The memory also retains instructions related to decoding a Broadcast TMSI (B-TMSI) included in the page message. The B-TMSI comprises retransmission status bits and a group of services that indicates one or more services are available. Further, the memory retains instructions related to ascertaining a Primary Services Group (Pr-SG) as a function of a first portion of the Pr-TMSI and services enabled and iteratively determining a secondary Services Group (S-SG) as a function of the Pr-SG, the group of services, the retransmission status bits, and a highest priority service received for a first time. The instructions also relate to conveying a Secondary TMSI (S-TMSI) that includes the S-SG and an identifier of one service included in the S-SG, establishing a layer three signaling connection and exchanging messages related to the one service identified in the S-TMSI. The energy indicates a page message. The S-SG is initially set equal to Pr-SG. The processor is coupled to the memory and is configured to execute the instructions retained in the memory.

Another aspect relates to a wireless communications apparatus that receives a multiple location based-services page transmitted to a plurality of users. The apparatus includes means for storing a Primary Temporary Mobile Station Identity (Pr-TMSI) and means for detecting energy on a Broadcast Paging Indicator (B-PI). The energy indicates a page message. The apparatus also includes means for decoding a Broadcast TMSI (B-TMSI) included in the page message. The B-TMSI comprises retransmission status bits and a group of services that indicates one or more services are available. Further, the apparatus includes means for generating a Primary Services Group (Pr-SG) as a function of a first portion of the Pr-TMSI and services enabled and means for iteratively evaluating a secondary Services Group (S-SG) as a function of the Pr-SG, the group of services, the retransmission status bits, and a highest priority service received for a first time. The S-SG is initially set equal to Pr-SG. Means for transmitting a Secondary TMSI (S-TMSI) that includes the S-SG and an identifier of one service included in the S-SG and means for receiving messages related to the service identified in the S-TMSI are also included in apparatus.

Another aspect relates to a computer program product comprising a computer-readable medium. The computer-readable medium includes a first set of codes for causing a computer to store a Primary Temporary Mobile Station Identity (Pr-TMSI) and a second set of codes for causing the computer to detect energy on a Broadcast Paging Indicator (B-PI). The energy indicates a page message. The computer-readable medium also includes a third set of codes for causing the computer to decode a Broadcast TMSI (B-TMSI) included in the page message. The B-TMSI comprises retransmission status bits and a group of services that indicates one or more services are available. The computer-readable medium also includes a fourth set of codes for causing the computer to generate a Primary Services Group (Pr-SG) as a function of a first portion of the Pr-TMSI and services enabled and a fifth set of codes for causing the computer to iteratively determine a secondary Services Group (S-SG) as a function of the Pr-SG, the group of services, the retransmission status bits, and a highest priority service received for a first time. The S-SG is initially set equal to Pr-SG. Further, computer-readable medium includes a sixth set of codes for causing the computer to transmit a Secondary TMSI (S-TMSI) that includes the S-SG and an identifier of one service included in the S-SG and a seventh set of codes for causing the computer to receive messages related to the service identified in the S-TMSI.

Yet a further aspect relates to at least one processor configured to receive a multiple location based-services page. The processor includes a first module for retaining a Primary Temporary Mobile Station Identity (Pr-TMSI), a second module for detecting energy on a Broadcast Paging Indicator (B-PI) and a third module for decoding a Broadcast TMSI (B-TMSI) included in the page message. The energy indicates a page message. The B-TMSI comprises retransmission status bits and a group of services that indicates one or more services are available. Also included in processor is a fourth module for ascertaining a Primary Services Group (Pr-SG) as a function of a first portion of the Pr-TMSI and services enabled and a fifth module for iteratively determining a secondary Services Group (S-SG) as a function of the Pr-SG, the group of services, the retransmission status bits, and a highest priority service received for a first time. The S-SG is initially set equal to Pr-SG. Further, the processor includes a sixth module for conveying a Secondary TMSI (S-TMSI) that includes the S-SG and an identifier of one service included in the S-SG, a seventh module for establishing a layer three signaling connection, and an eighth module for exchanging messages related to the one service identified in the S-TMSI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of the various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a wireless communication system in accordance with various aspects presented herein.

FIG. 2 illustrates a multiple access wireless communication system according to one or more aspects.

FIG. 3 illustrates a multi-users/multi-services paging system for location-based services.

FIG. 4 illustrates a multi-users/multi-services page receiver system for location-based services.

FIG. 5 illustrates an example services table.

FIG. 6 illustrates structures for different Pr-TMSI Types that can be assigned.

FIG. 7 illustrates example structures for the secondary TMSI (S-TMSI).

FIG. 8 illustrates an example structure of a paging indicator channel (PICH).

FIG. 9 illustrates an example structure of a Broadcast TMSI (B-TMSI) sent in PagingType1 RRC message.

FIG. 10 illustrates a method for receiving a multiple location based-services page transmitted to a multitude of users.

FIG. 11 illustrates a method for receiving a new Pr-TMSI from a network after detecting a new location area.

FIG. 12 illustrates a method for receiving a multi-services, multi-user page.

FIG. 13 illustrates a method for transmitting a multi-services, multi-user page in accordance to one or more aspects presented herein.

FIG. 14 illustrates an example of a multi-user/multi-service broadcast paging.

FIG. 15 illustrates a system that facilitates receiving a multi-user/multi-services page in accordance with one or more of the disclosed aspects.

FIG. 16 illustrates a system that facilitates transmitting location based-services pages to multiple mobile devices in accordance with various aspects presented herein.

FIG. 17 illustrates an exemplary wireless communication system.

FIG. 18 illustrates an example system that transmits a location based-services page to a multitude of users.

FIG. 19 illustrates an example system that receives a multiple location based-services page transmitted to a multitude of users.

### GLOSSARY OF TERMS

Pr-TMSI: Primary Temporary Mobile Station Identifier. The Pr-TMSI address contains two parts and is assigned from the network to the user equipment only once. The first part of the Pr-TMSI address is all the services supported in the location where the user equipment is located and all the services the user equipment supports. The second part is a unique address assigned to the user equipment. The Pr-TMSI is only sent Over The Air once as part of Layer 3 (RRC) signaling once the user equipment crosses a new location/routing area. The user equipment saves the Pr-TMSI (e.g., in memory) to be used later in bitwise operations. The Pr-TMSI is not sent again unless the user equipment goes to a new location/routing area. The only place where Pr-TMSI is used again Over The Air is in voice calls.

S-TMSI: Secondary Temporary Mobile Station Identifier is constructed by the user equipment and has two parts. The first part of the S-TMSI address is the service that the user equipment and the network are negotiating. The second part is identical to the second part of the Pr-TMSI (unique identification of the user equipment). The first part of S-TMSI identifies which service the user equipment is currently establishing. Once the network sees this address in the establishment message, the network knows which service the user equipment is replying to (since the network is initially sending many messages and needs to know to which message this user equipment is replying). S-TMSI is used in the remainder of the Layer 3 (RRC) signaling.

B-TMSI: Broadcast Temporary Mobile Station Identifier. The B-TMSI address is what is sent as part of the broadcast page (e.g., Paging Type 1 RRC message). The B-TMSI contains all the Services for which the broadcast page is intended. This B-TMSI address has two parts. The first part indicates to the user equipment which services are now being negotiated (ready to be decoded), and the second part tells the user equipment which of these services negotiated are new or re-transmitted. The B-TMSI addressing is part of the Layer 3 (RRC) Signaling.

B-PI: The Broadcast Paging Indicator is the last twelve bits of the Physical Paging Channel (PICH). This indicator tells the user equipment if a broadcast message is sent or a normal voice/data call is made. If the network is sending a broadcast message, it sets these bits to all 1's but if a voice call page is sent, then the network sets all these bits to all 0's. This is not part of Layer 3, but this is part of the physical layer. This is the first check the user equipment uses to distinguish the type of page transmitted.

Pr-SG: Primary Service Group constructed in the user equipment. The Pr-SG is constructed based on the services that are enabled in a User Interface (UI) menu and which Service Group (SG) the user equipment is assigned in a Pr-TMSI. The Pr-SG is not sent Over the Air and has no significance to the network.

S-SG: Secondary Service Group constructed by the user equipment based on the results of bitwise operations. The S-SG tracks the services messages that the user equipment has received to help mitigate receiving the same message sent in a page re-transmission.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

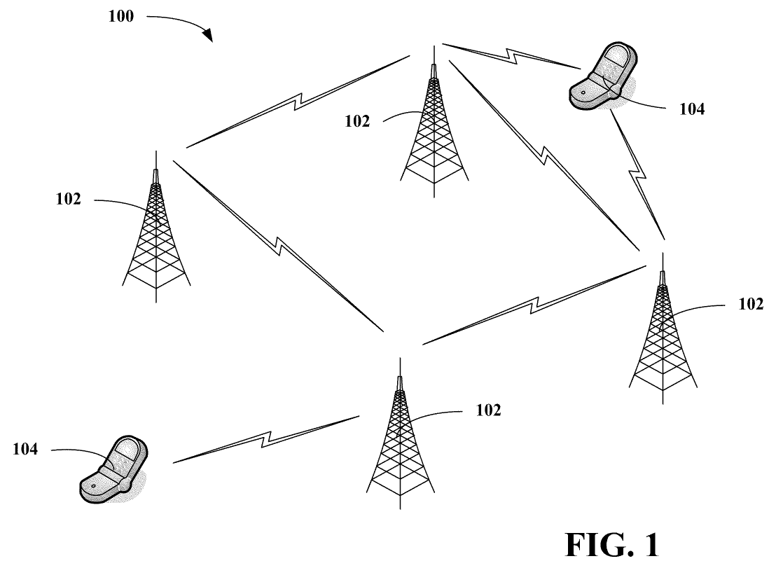

Referring now to FIG. 1, a wireless communication system 100 in accordance with various aspects presented herein is illustrated. System 100 can comprise one or more base stations 102 in one or more sectors that receive, transmit, repeat, and so forth, wireless communication signals to each other and/or to one or more mobile devices 104. Each base station 102 can comprise multiple transmitter chains and receiver chains (e.g., one for each transmit and receive antenna), each of which can in turn comprise a plurality of components associated with signal transmission and reception (e.g., processors, modulators, multiplexers, demodulators, demultiplexers, antennas, and so forth). Each mobile device 104 can comprise one or more transmitter chains and receiver chains, which can be utilized for a multiple input multiple output (MIMO) system. Each transmitter and receiver chain can comprise a plurality of components associated with signal transmission and reception (e.g., processors, modulators, multiplexers, demodulators, demultiplexers, antennas, and so on), as will be appreciated by one skilled in the art.

System 100 can be configured to transmit a single paging message that includes one or more location based services to multiple destinations (e.g., mobile devices, users, and so forth) in a certain location (e.g., geographic area). Location based services can be classified into various categories, such as public safety services, target subscriber notifications, traffic monitoring, city sightseeing, location dependent content broadcast, and other services. Public Safety Services include emergency alert services (e.g., tornado warning, crime, car chase, terrorism, Amber alerts, fire alerts, and the like). Target Subscriber Notifications inform users on an ongoing basis with information such as zone and billing rates that are currently applicable, such as when the mobile device (e.g., user) enters a location with potentially different rates. Traffic Monitoring can inform users about road congestion, average flow rate, vehicle occupancy, and other traffic related information. City Sightseeing delivers specific information to sightseers (e.g., visitors, tourists, and the like). City Sightseeing information includes locations of banks, airports, historical sites, restaurants, and so forth, as well as other information that might be useful or of interest to the sightseer. Location Dependent Content Broadcast information is automatically broadcast by the network (e.g., base station) and provides information to users (through respective mobile devices) in a certain area. The broadcast information can be related to localized advertising of merchants (e.g., stores or restaurants in the area) as well as other information.

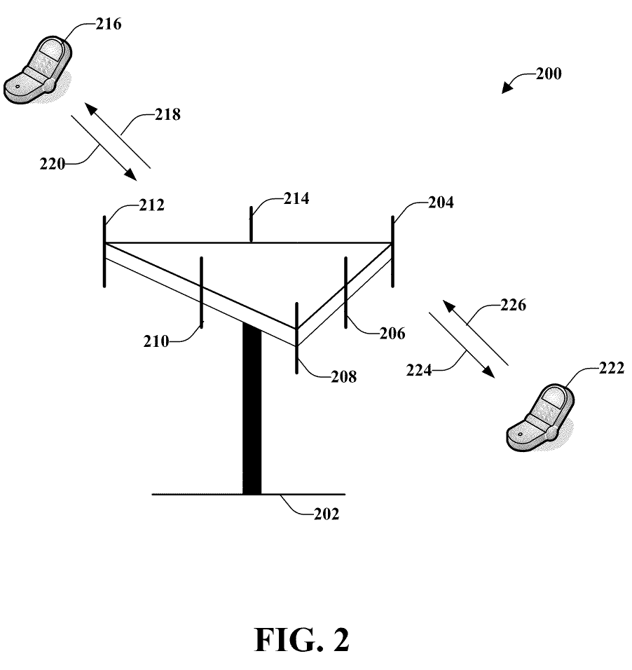

Referring now to FIG. 2, a multiple access wireless communication system 200 according to one or more aspects is illustrated. A wireless communication system 200 can include one or more base stations in contact with one or more user devices. Each base station provides coverage for a plurality of sectors. A three-sector base station 202 is illustrated that includes multiple antenna groups, one including antennas 204 and 206, another including antennas 208 and 210, and a third including antennas 212 and 214. According to the figure, only two antennas are shown for each antenna group, however, more or fewer antennas may be utilized for each antenna group. Mobile device 216 is in communication with antennas 212 and 214, where antennas 212 and 214 transmit information to mobile device 216 over forward link 218 and receive information from mobile device 216 over reverse link 220. Forward link (or downlink) refers to the communication link from the base stations to mobile devices, and the reverse link (or uplink) refers to the communication link from mobile devices to the base stations. Mobile device 222 is in communication with antennas 204 and 206, where antennas 204 and 206 transmit information to mobile device 222 over forward link 224 and receive information from mobile device 222 over reverse link 226. In a FDD system, for example, communication links 218, 220, 224, and 226 might utilize different frequencies for communication. For example, forward link 218 might use a different frequency than the frequency utilized by reverse link 220.

Each group of antennas and/or the area in which they are designated to communicate may be referred to as a sector of base station 202. In one or more aspects, antenna groups each are designed to communicate to mobile devices in a sector or the areas covered by base station 202. A base station may be a fixed station used for communicating with the terminals.

In communication over forward links 218 and 224, the transmitting antennas of base station 202 can utilize beamforming in order to improve a signal-to-noise ratio of forward links for the different mobile devices 216 and 222. Also, a base station utilizing beamforming to transmit to mobile devices scattered randomly through its coverage area might cause less interference to mobile devices in neighboring cells than the interference that can be caused by a base station transmitting through a single antenna to all the mobile devices in its coverage area.

In accordance with some aspects, system 200 provides a paging service that is based on a Paging Indicator Channel (PICH) that includes changes to a higher layer addressing mechanism and Radio Resource Control (RRC) messages including PagingType1 Messages and Location Area Update. In accordance with some aspects, users (e.g., mobile devices) are congregated into groups identified with the services supported by each mobile device and the network (e.g., base station 202) in the location area. The network can assign a new set of addresses to uniquely identify each mobile device and, at about the same time, recognize the services supported by both the mobile device and/or the network. In accordance with some aspects, the addresses assigned to a mobile device are based on the addresses and identifications associated with the 3GPP (Third Generation Partnership Project) Specification, however, other addresses and identifications can be utilized with the disclosed aspects.

When several multicast services are to be sent to all users in a certain area, the network (e.g., base station 202) can send one paging message containing a broadcast address of all the services intended for all the subscribers in the specified location. Each mobile device decodes this address, identifies the services sent in the page, and responds to one or more of the services that are supported by the mobile device. System 200 can also mitigate false alarm pages and hashing collision scenarios, which might affect battery standby time (e.g., wasting resources). Hashing collisions are mitigated through improved addressing aspects, which will be described in further detail below.

An advantage of the disclosed aspects is improved management of network resources by broadcasting a multitude of different services in a single page to as many mobile devices as possible in a certain area. Further, the disclosed aspects assist the network (e.g., base station 202) by mitigating the transmission of a dedicated page that includes only one service to each mobile device. Therefore, with only a few broadcast paging messages, all the services messages can reach the intended mobile devices in less time and with less paging resources.

From a service provider's prospective, a multitude of different location-based services messages can reach all intended subscribed mobile devices in a single attempt (or a limited number of attempts). Thus, the disclosed aspects can increase the usage of location-based services and the applications market for such services. Further, users can benefit by the growth of these services and applications.

In addition, the disclosed aspects can provide a more reliable and faster delivery of emergency alert messages in the case of national and/or regional emergencies. The various aspects can also increase the number of advertising, sightseeing, and traffic monitoring messages as well as other messages. This increased usage can encourage service providers to increase the number of multicast applications without risking network resources and capacity of the network. A page re-transmission mechanism is another aspect provided herein that can enable verification whether each mobile device has received the intended page without missing services. This can be useful in areas that have limited coverage and/or unreliable transmissions.

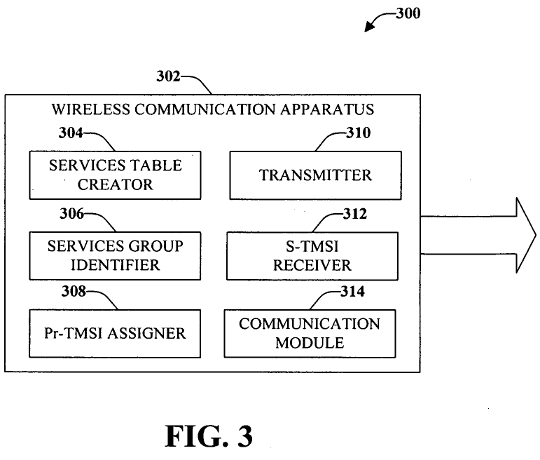

FIG. 3 illustrates a multi-users/multi-services paging system 300 for location-based services. Conventional systems provide a point-to-multipoint application transferred from one cell to multiple users on a broadcast message. The disclosed aspects can be described as “point-of-multi-services-broadcast to/from multiple-point-with-multi-services-decoding”.
Point [Multi-Service] [symbol] Multipoint[Multi-Service]

A mobile device can decode the broadcast messages in a connected/dedicated mode carried on the shared channels after successfully decoding the broadcast paging indicator portion on the paging channel. Multiple shared channels in connected modes can be sent, each carrying a different set of services.

System 300 includes a wireless communication apparatus 302 that is shown to be transmitting data through a channel. Although depicted as transmitting data, wireless communication apparatus 302 can also receive data through the channel (e.g., wireless communication apparatus 302 can transmit and receive data at substantially the same time, wireless communication apparatus 302 can transmit and receive data at differing times, or combinations thereof). Wireless communication apparatus 302, for example, can be a base station (e.g., base station 102 of FIG. 1).

In accordance with some aspects, wireless communications apparatus 302 is a visiting location registry (VLR). A Home Location Registry (HLR) can convey information related to one or more mobile devices to the wireless communications apparatus 302 (e.g., VLR). The information supplied by the HLR can include an IMSI (International Mobile Subscriber Identity) of each mobile device and the services to which each mobile device has subscribed.

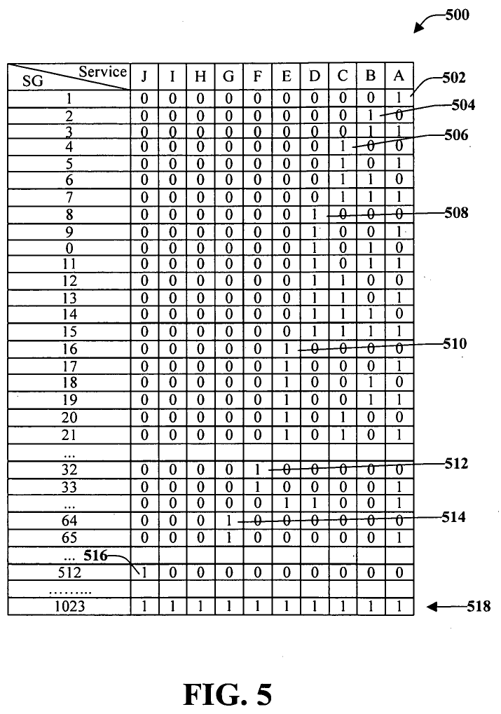

Wireless communications apparatus 302 includes a Services Table Creator 304 that is configured to create a Services Table (ST) based on the services that the wireless communications apparatus 302 supports in a specific area (e.g., geographic location). In accordance with some aspects, a services table can be utilized as a substitute for providing a universal identity to each service. The order of each service included in the services table can be different for each VLR (e.g., wireless communication apparatus 302). According to some aspects, the services table is constructed at the network side and does not need to be matched at the mobile device side. Further examples and details related to the services table will be provided below with reference to FIG. 5.

At substantially the same time as a mobile device enters the location area supported by wireless communications apparatus 302, a Temporary Mobile Station Identity (TMSI) can be assigned to the mobile device (e.g., user). A services group identifier 306 assigns each mobile device to a Services Group (SG). In accordance with some aspects, the assigned Services Group can be included in the TMSI. The Services Group (SG) is assigned to a mobile device as a function of the services to which the mobile device has subscribed. In accordance with some aspects, services group identifier 306 can assign a mobile device to a Services Group in some locations according to which services the wireless communications apparatus 302 supports in that location. For example, a mobile device might support a certain service that the wireless communications apparatus 302 does not offer. In this situation, the mobile device is only assigned to a services group that is supported by both the mobile device and the wireless communications apparatus 302. A services group can be assigned to a multitude of mobile devices and is part of a Pr-TMSI. In accordance with some aspects, based on the services supported by a network (e.g., wireless communications apparatus 302), a services table is created. The services table can also include at least one services group.

In accordance with some aspects, for a number of services supported (e.g., 10 services), there is a Service Group that is unique to each service. For example, for Service A, the service identifier is SG 1 (2⁰). For Service B, the service identifier is SG 2 (2¹). For service C, the service identifier is SG 4 (2²), and so forth. In this example, for service J, the service identifier is group 512 (2⁹).

Also included in a wireless communications apparatus 302 is a Primary Temporary Mobile Station Identity (Pr-TMSI) assigner 308. At substantially the same time as a mobile device enters an area serviced by wireless communications apparatus 302, a Pr-TMSI can be assigned to the mobile device. The Pr-TMSI can include at least one services group and a device identifier associated with the mobile device.

In accordance with some aspects, the Pr-TMSI is assigned in service request messages (e.g., RRC signaling messages). It should be noted that the terms “primary” and “secondary” are utilized herein, however, such terms are utilized merely to distinguish the types of TMSI and are not meant to provide any specific meaning to the terms (e.g., not meant to imply that a particular TMSI is better than another).

The Pr-TMSI assigner 308, based on the information received from the HLR, can include a Services Group for services to which the mobile device subscribes. For example, a mobile device supports services A, B and E from a number of services (e.g., 10 services) and, as a function of these supported services, the mobile device will be assigned to a certain Services Group (e.g., SG 19 according to the example Services Table 500 of FIG. 5, which is described in detail below).

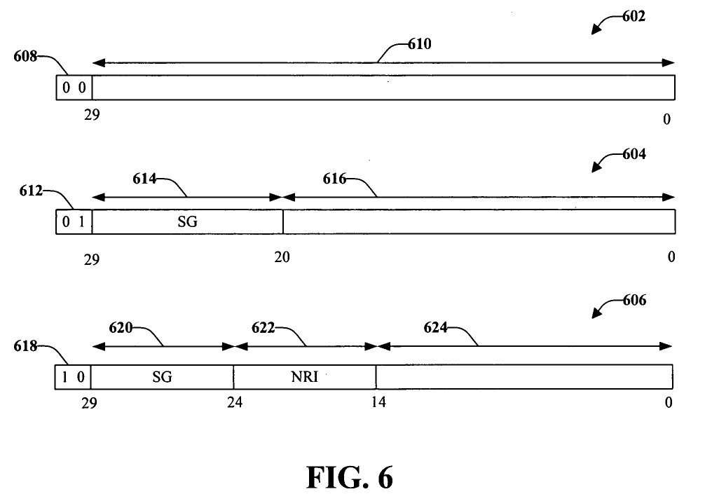

There can be a number of different Pr-TMSI Types that can be assigned to a mobile device. For example, a “Pr-TMSI Type 1” can be assigned if there are no services assigned to the mobile device. Other Pr-TMSI types include a “Pr-TMSI Type 2” and a “Pr-TMSI Type 3”. Further information related to the various Pr-TMSI types are provided below with reference to FIG. 6. According to some aspects, services groups can be assigned to a multitude of different mobile devices and included as part of a Primary TMSI (Pr-TMSI).

The Pr-TMSI can also include a priority of the services included in the service group. The priority of services can rank the services from a highest priority to a lowest priority, wherein services with a higher priority are to be received by the mobile device before receiving services with a lower priority. The priority can be different in each location area depending on which services are supported by the network (e.g., wireless communications apparatus 302). The mobile device and network generally do not have an ordered list of services common on both sides until the priority is established in the Pr-TMSI. However, the network has the ability to identify the services that are supported by both the mobile device and the location area serving the mobile device. The order of the services can be utilized to construct the Services Table. Additionally or alternatively, this list of services can be mapped one to one at the mobile device side. Therefore, in the a service request message (e.g., RRC message) in which the network assigns the Pr-TMSI to the mobile device, the mapping information of services can be sent to map a particular service at the mobile device to the particular service in that location.

The priority of each of the mapped service can also be set and sent in an RRC message. The network (e.g., wireless communications apparatus 302,), sets the priority of each service and the priority might be different in each location area, depending on which service the network supports.

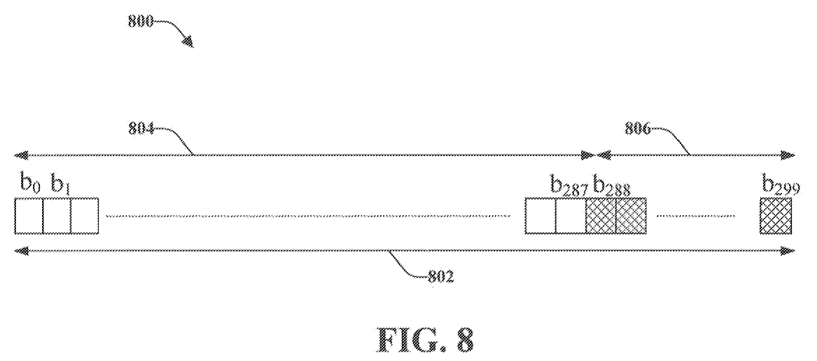

Wireless communications apparatus 302 also includes a transmitter 310 that is configured to transmit a broadcast services page message, which is a multi-user/multi-service page. The broadcast services page message is transmitted to all the mobile devices in the area serviced by wireless communication apparatus 302. In accordance with some aspects, a Paging Indicator Channel (PICH) can be utilized to distinguish between types of pages. This can be performed through utilization of reserved bits (e.g., Broadcast Paging Indicator (B-PI) bits) on PICH in order for wireless communications apparatus 302 to signal a different service types (e.g., other than known service types such as voice, data, and so forth). When a broadcast service page is transmitted, wireless communications apparatus 302 sets all Paging Indicators (PI) in PICH to “all 1s” in addition to setting the remaining twelve bits in PICH (Broadcast Paging Indicator, B-PI) to “all 1s”. However, if the page is intended for a specific user (e.g., voice call, data call, and so on), the B-PI bits are set to “all 0s”. A structure of a paging indicator channel sent in the transmission will be provided below with reference to FIG. 8.

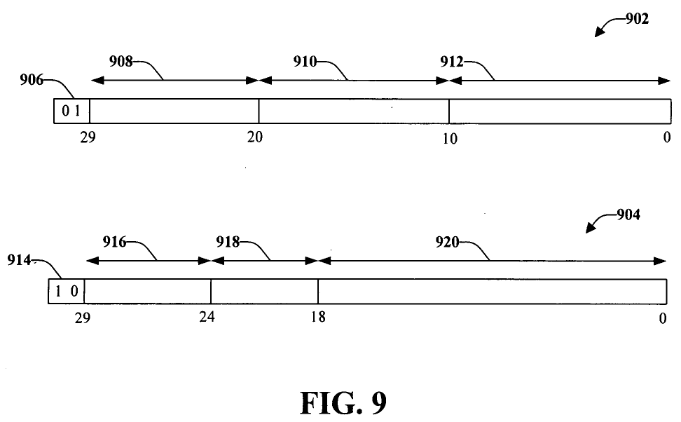

In accordance with some aspects, wireless communications apparatus 302 attaches a Broadcast TMSI (B-TMSI) to paging message (e.g., a layer three paging message, a Paging Type 1 message). A B-TMSI transmitted in PagingType1 RRC message has the structure of FIG. 9, which will be described in further detail below. B-TMSI allows wireless communications apparatus 302 (e.g., network) to transmit multiple services in the same page. The multiple services are services that are offered by wireless communications apparatus 302 and can be contained in a Primary Services Group (Pr-SG).

Additionally, retransmission status bits for each service can be attached to B-TMSI. A retransmission mechanism takes into account that some mobile devices might be missing (e.g., did not receive) a subset of the broadcast pages. Thus, the re-transmission mechanism can notify the mobile devices as to which service sent in the page is retransmitted, which can be enabled through the B-TMSI. Thus, wireless communications apparatus 302 can retransmit pages as many times as need for a period of time, depending on the urgency of the broadcast page.

In accordance with some aspects, wireless communications apparatus 302 (e.g., networks) can retransmit a duplicate broadcast message indicating it is a new message, depending on the urgency of the message (e.g., for emergency messages). In such a manner, networks can warn users (through respective user devices) a number of times about a disaster or other situations so that the messages (e.g., alerts) are not ignored and that the messages reach as many users as possible.

In addition to idle mode, the broadcast messages can be carried on the shared channels in connected/dedicate modes (e.g., High Speed Physical Downlink Shared Channel (HS-PDSCH), High Speed Shared Control Channel (HS-SCCH), and so forth). In such a manner, all users can be assigned the same shared channel in connected mode in order for the users (e.g., mobile devices) to read the same broadcast messages.

In accordance with some aspects, multiple shared channels in connected/dedicated mode can be transmitted, each carrying a different set of services (e.g., multiple HS-PDSCH/HS-SCCH or other shared channels). Thus, one page can indicate multiple services while the broadcast messages for the services associated with the page can be carried on the multiple shared channels on a downlink (e.g., from the network to the mobile devices).

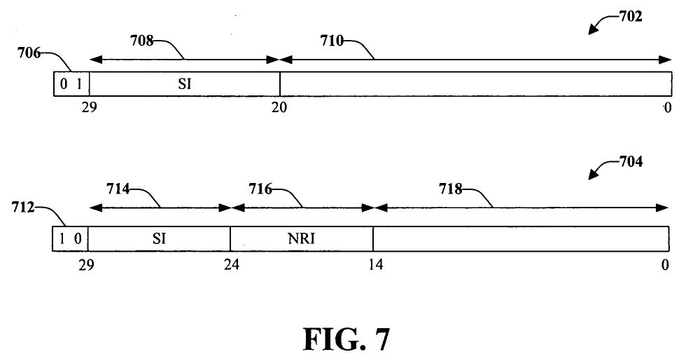

Wireless communications apparatus 302 can also include a S-TMSI receiver 312 that is configured to receive a secondary TMSI (S-TMSI) from a mobile device. The secondary TMSI (S-TMSI) is utilized by both the network and the mobile device to establish layer three signaling messages (e.g., RRC connection request, RRC connection setup, and so forth). The S-TMSI is only used after the mobile device receives the broadcast page with a service (e.g., only when Broadcast Paging Indicator (B-PI) bits are all set to all “1”s). A Service Identifier (SI) attached in the S-TMSI indicates to the network the service (from the group of services) to which mobile device is responding (and which is under negotiation). The remaining bits can be utilized by the network to identify the mobile device (e.g., contain the unique device identifier of the mobile device). Further information relating to S-TMSI will be provided with reference to FIG. 7 below.

Wireless communication apparatus 302 also includes a communication module 314 that is configured to exchange layer three signaling messages with one or more mobile devices to convey the identified service (that is under negotiation) to the device(s).

In accordance with some aspects, a second (or subsequent) service might be supported by both communications apparatus 302 and mobile device and/or new and/or additional services might need to be conveyed to the mobile devices. Thus, transmitter 310 can transmit a subsequent broadcast services page message that includes a second B-TMSI. The second B-TMSI can include retransmission status bits that indicate the services are a retransmission or a new transmission. S-TMSI receiver 312 can receive a second (or subsequent) S-TMSI from the mobile device(s). The second S-TMSI can identify a second (or subsequent) service (from the group of services) that is under negotiation. Communication module 314 can exchange layer three signaling messages to convey the second (or subsequent) service.

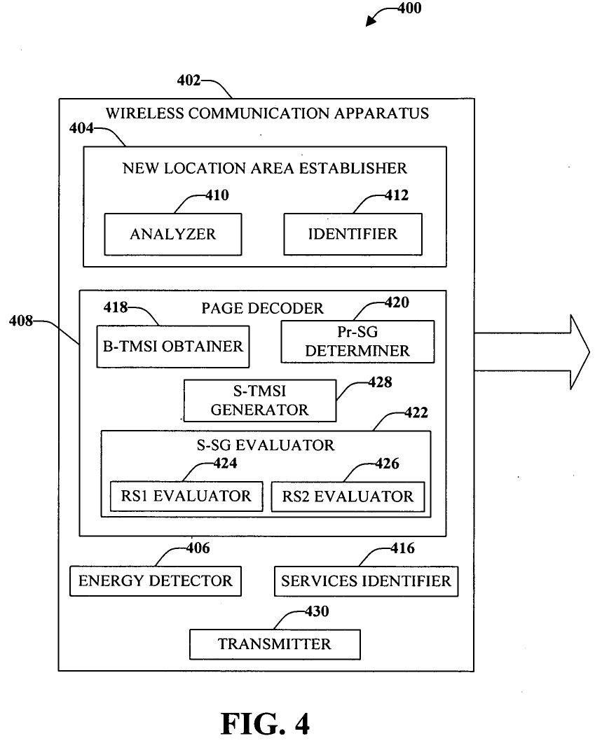

FIG. 4 illustrates a multi-users/multi-services page receiver system 400 for location-based services. System 400 includes a wireless communication apparatus 402 that is shown to be transmitting data through a channel. Although depicted as transmitting data, wireless communication apparatus 402 can also receive data through the channel (e.g., wireless communication apparatus 402 can concurrently transmit and receive data, wireless communication apparatus 402 can transmit and receive data at differing times, or combinations thereof). Wireless communication apparatus 402, for example, can be a mobile device (e.g., access terminal 116 of FIG. 1, access terminal 122 of FIG. 1, . . . ), or the like. Included in wireless communications apparatus is a new location area establisher 404, an energy detector 406, and a multi-user/multi-service page decoder 408.

New location area establisher 404 is configured to obtain information related to a serving cell at substantially the same time as the new serving cell is selected. Included in location area establisher 404 is an analyzer 410 that is configured to read a Pr-TMSI in a service request message (e.g., a RRC message) and identify the Pr-TMSI type and Services Group. The Pr-TMSI can be retained, such as in a storage medium. An identifier 412 is configured to obtain a services order mapping and priorities. Higher Layers can identify the services enabled by the user through a User Interface menu (associated with wireless communications apparatus 402). The Pr-SG can be constructed based on the services the user enables from a user interface menu and which service group the wireless communications apparatus 402 is assigned in Pr-TMSI. The Pr-SG is not sent over the air and has little, if any, significance to the network.

Energy detector 406 is configured to detect energy on a Paging Indicator (PI) and/or Broadcast Paging Indicator (B-PI). If the B-PI does not contain energy, the paging message is not a broadcast message. If energy is detected on both the PI and the B-PI, the energy indicates that there is a page (e.g., page message, broadcast message, and so forth) available for wireless communications apparatus 402. In accordance with some aspects, the B-PI can be twelve bits included in a PICH. The page can be decoded by multi-user/multi-service page decoder 408.

A services identifier 416 can be configured to determine whether at least one service is enabled (e.g., turned on). For example, if the user does not desire to receive any services, the user can disable (e.g., turn off) all services or a subset of services. If the user has disabled all services, wireless communications apparatus 402 ignores any multi-services pages received. However, in accordance with some aspects, the user will enable at least one service and wireless communications apparatus 402 will not ignore multi-services pages received.

Included in multi-user/multi-service page decoder 408 is a B-TMSI obtainer 418 that is configured to obtain and decode a B-TMSI included in the broadcast page message. A B-TMSI can contain a group of services that indicates one or more services are available (e.g., all the services for which the broadcast paging is intended). The B-TMSI can also include retransmission status bits that indicate whether the transmission is a new message and/or a retransmitted message. Wireless communications apparatus 402 can be configured to receive broadcast messages in idle mode and/or connected mode. If in connected mode, wireless communications apparatus 402 can decode the broadcast messages carried on the shared channels after successfully decoding the broadcast paging indicator portion on the paging channel.

A Primary Services Group (PR-SG) determiner 420 is configured to ascertain a Pr-SG as a function of a first portion of the Pr-TMSI and the services enabled (as determined by services identifier 416. Also included is a Secondary Service Group (S-SG) evaluator 422 that is configured to iteratively determine a S-SG as a function of the Pr-SG, the group of services included in the B-TMSI, the retransmission status bits included in the B-TMSI, and a highest priority service received for a first time. The S-SG can be initially set equal to Pr-SG. The S-SG tracks which services messages the wireless communication apparatus 402 received to mitigate receiving the same message sent in a page retransmission.

The S-SG s can be calculated as a function of a bitwise operation. A first result evaluator (RS1) 424 can determine a first value by bitwise ANDing (&) Multi-Service bits in a B-TMSI (included in the page message) with services enabled in the Pr-SG. If the first value is equal to zero, wireless communications apparatus 402 can enter an idle state (e.g., DRX cycle). The first value can be equal to zero if all services are disabled, the wireless communications apparatus 402 is not assigned services, the wireless communications apparatus 402 is not authorized to access services sent in the page, or combinations thereof. A second result evaluator (RS2) 426 can determine a second value by bitwise ORing (∥) the retransmission status bits in the B-TMSI with the S-SG. Secondary Service Group evaluator 422 can calculate the S-SG by bitwise ANDing (&) the first value with the second value.

In accordance with some aspects, the PR-TMSI is assigned in a layer three message page. Apparatus 402 can be configured to read a priorities of services included in the Pr-TMSI. The priorities of services can be saved by apparatus 402 for later use when calculating the S-SG.

Also included in wireless communications apparatus 402 is a Secondary-TMSI (S-TMSI) generator 428 that is configured to convey a S-TMSI that includes the S-SG and an identifier of one service included in the S-SG (the service that is currently being negotiated). For example, the S-TMSI can include a request for an update from Higher Layers for priorities of services with bit “1” in the S-SG. S-TMSI generator 428 can construct a S-TMSI with SI for the service with the highest priority.

A transmitter 430 can send a service request message (e.g., an RRC connection request) at substantially the same time as the S-TMSI is transmitted to establish a layer three signaling connection. The apparatus 402 can exchange messages with the network that relate to the service identified in the S-TMSI.

Upon receipt of a service request release (e.g., RRC connection release) for the service with the highest priority, the bit in the S-SG corresponding to the service for which a message was received can be reset. Thus, the bit corresponding to the service contained in the S-SG is toggled to “0” to override the S-SG when the broadcast message is exchanged successfully between receiver (e.g., apparatus 402) and transmitter (e.g., network).

In accordance with some aspects, wireless communication apparatus 402 can detect re-transmitted paging messages. For example, paging messages can be re-transmitted if the message is an important and/or urgent message or for other reasons. If the re-transmitted paging message has already been received at wireless communications apparatus 402, the message can be safely ignored, thus mitigating the number of received duplicate broadcast messages.

FIG. 5 illustrates an example services table 500. A “1” represents that the indicated service is supported, and “0” represents that the indicated service is not supported. The illustrated table 500 is constructed for a maximum of ten services. However, it should be understood that more or fewer services could be utilized in accordance with the disclosed aspects. For example, if a network (e.g., wireless communications apparatus 302 of FIG. 3) supports a fewer number of services, a table is constructed in substantially the same manner as the illustrated table, with a fewer number of bits. Alternatively, if the network supports more services, a table is constructed with more bits.

In the example services table 500, illustrated at 502 is the Service Identifier (SI) for Service A. At 504, is the SI for Service B. The SI for Service C is at 506. The SI for Service D is located at 508 and the SI for Service E is located at 510. Further, at 512 is the SI for Service F, at 514 is the SI for Service G and at 516 is the SI for Service G. Each of the services (e.g., A, B, C, D, and so forth) can relate to different categories of service. For example, Service A can relate to public safety services, Service B can relate to city sightseeing, Service C can relate to target subscriber notifications, and so forth. If there are multiple services, such as if Service A and Service B are supported, “1” is indicated for both services. Further, if all services are supported, all Services are set to “1”, as indicated at 518. Thus, a single paging message 502 to 518 can be utilized to convey information related to a multitude of services (e.g., paging message 518 indicates that all services are supported).

FIG. 6 illustrates structures for different Pr-TMSI Types that can be assigned. These types are Pr-TMSI Type 1 (602), Pr-TMSI Type 2 (604), and Pr-TMSI Type 3 (606). For Pr-TMSI Type 1 (602), the first two left-most bits 608 indicate the type. Pr-TMSI Type 1 (602) has no Service Groups attached. In accordance with some aspects, the PR-TMSI can be thirty bits (e.g., bits 0 to 29), as indicated at 610.

The first two left-most bits 612 of Pr-TMSI Type 2 (604) indicate the type. Pr-TMSI Type 2 (604) has a Service Group (SG) 614 attached but does not have NRI bits. As illustrated, the Service Group 614 can have ten bits (e.g., bits 20 to 29). There can be twenty bits (e.g., bits 0 to 19) that represent the remaining parts 616 of the Pr-TMSI Type 2 (604). The remaining bits 616 can be assigned by the network (e.g., wireless communications apparatus 302 of FIG. 3) and no restrictions are needed in accordance with some aspects.

For the Pr-TMSI Type 3 (606), the first two left-most bits 618 indicate the type. Pr-TMSI Type 3 (606) has a Service Group (SG) 620 attached. According to some aspects, the Service Group 620 can be up to six bits (e.g., bits 24 to 29). Also included can be NRI bits 622, which can be up to ten bits (e.g., bits 14 to 23). The NRI bits 622 can be assigned if Intra domain connection of Radio Access Network (RAN) nodes to multiple Core Network (CN) domain Nodes is applied. A fourteen bits address 624 (e.g., bits 0 to 13) is assigned by the network (e.g., wireless communications apparatus 302 of FIG. 3) and no restrictions are needed.

The Pr-TMSI assigned to the mobile device (e.g., by Pr-TMSI assigner 306 of FIG. 3) can include service group (e.g., 19 based on the example services table 500 in FIG. 5 above) in the left-most ten bits, such as “0000010011”. The mobile device can be assigned Pr-TMSI Type 1 (602) if there are no services assigned to the user (e.g., either the user is not subscribed to any broadcast service, or the VLR does not support any service). In the case where the mobile device is receiving a page for a voice call or a data call (not a broadcast page), the Pr-TMSI contents (SG) can have no significance at the mobile device side. The mobile device can use Pr-TMSI bits to identify the page and establish a RRC connection. However, when a broadcast page is received by the mobile device (B-PI bits are all 1's), then the mobile device can use the SG bits in Pr-TMSI to identify the page and the service, as will be described in further detail below. The Pr-TMSI is used by the mobile device to identify the services for Pr-TMSI Type 1 (602) and PR-TMSI Type 2 (604). The Pr-TMSI is not utilized by the mobile device to establish a RRC connection with the network.

FIG. 7 illustrates example structures for the secondary TMSI (S-TMSI). A S-TMSI can be reserved in a VLR and constructed by mobile device higher layers. The S-TMSI is sent over the air when an RRC connection is established for broadcast service. A Service Identifier (SI) attached in S-TMSI indicates to the network the service the mobile device is responding to after receiving the Multi-Services page. The remaining bits are utilized by the network to identify the mobile device. A S-TMSI Type 1 (702) and a S-TMSI Type 2 (704) are illustrated. The first two left-most bits 706 of S-TMSI Type 1 (702) indicate the type. S-TMSI Type 1 702 has Service Identifier (SI) bits 708 attached but does not have NRI bits. In accordance with some aspects, the Service Identifier 708 has about ten bits (e.g., bits 20 to 29). A twenty bit address 710 (e.g., bits 0 to 19) assigned by the VLR can match the twenty bits assigned to a particular mobile device in Pr-TMSI Type 2 (604 of FIG. 6).

For S-TMSI Type 2 (704), the first two left-most bits 712 indicate the type. S-TMSI Type 2 (704) has Service Identifier (SI) 714 bits attached and NRI bits 716. The service identifier 714 can be about six bits (e.g., bits 24 to 29). There can be approximately ten bits NRI 716 assigned (e.g., bits 14 to 23) if Intra domain connection of RAN nodes to multiple CN domain Nodes is applied. About fourteen bits 718 (e.g., bits 0 to 13) can be assigned by the VLR and these bits can match the fourteen bits assigned to the particular mobile device in PR-TMSI Type 3 (706).

There is no Secondary TMSI associated with Pr-TMSI Type 1 (602 of FIG. 6) because S-TMSI is only used for broadcast service, and Pr-TMSI Type 1 (602 of FIG. 6) is assigned to mobile devices with no broadcast services. When the network assigns a Pr-TMSI to a mobile device, the network can reserve a S-TMSI for the same mobile device with the structure described above, depending on which Pr-TMSI type is used. S-TMSI is not sent over the air in the initial Location/Routing area updates. The RRC connection is utilized for addressing between the mobile device(s) and the network for broadcast services to identify a mobile device and services for which RRC connection is established.

FIG. 8 illustrates an example structure of a paging indicator channel (PICH) 800. Illustrated is one radio frame, represented at 802, which can be about ten milliseconds (ms). When a broadcast service page is sent (e.g., by transmitter 314 of FIG. 3), paging indication (PI) bits 804 in the PICH 800 are set to “1”s. In accordance with some aspects, there can be 288 bits for the paging indication, however, there can be a different number of bits 804 than 288 bits for the paging indication in accordance with other aspects. Additionally, the remaining bits, which can be, for example, twelve bits in the PICH can be set to “1”. These remaining bits are referred to as the Broadcast Page Indicator (B-PI) 806. Alternatively, if the page is intended for a specific user (e.g., voice call, data call), the B-PI bits 806 are set to “0”.

The network can attach B-TMSI to a Paging Type 1 message. A B-TMSI sent in PagingType1 RRC message has the structures as illustrated in FIG. 9. Illustrated are two types, a B-TMSI Type 1 (902) and a B-TMSI Type 2 (904). The first two left-most bits 906 of B-TMSI Type 1 (902) indicate the type. The next ten left-most bits 908 (e.g., bits 20 to 29) can indicate the multi-services for which the page is intended. The next ten bits 910 (e.g., bits 10 to 19) can identify the re-transmission status of each service in the page. The last ten bits 912 (e.g., bits 0 to 9) can be utilized by the mobile device. In accordance with some aspects, the last ten bits 912 are utilized by the network for various purposes.

The first two left-most bits 914 of B-TMSI Type 2 (904) indicate the type. B-TMSI Type 2 (904) is for the Pr-TMSI type 3 (6 bits SG). The next six left-most bits 916 (e.g., bits 24 to 29) can be utilized to indicate all the multi-services for which the page is intended (e.g., multi-services). The next six bits 918 (e.g., bits 18 to 23) can be utilized to identify the retransmission status of each service in the page. The last eighteen bits 920 (e.g., bits 0 to 17) might be reused and not utilized by the mobile device. According to some aspects, a subset of the last eighteen bits 920 can be utilized by the network for various purposes.

A B-TMSI can contain all the services the broadcast paging is intended for (this demonstrates the idea of Multi-Service Paging) which can be ten bits (for ten services supported) and six bits (for six services supported) and so forth. Multiple Services can be sent in the same page. In addition, re-transmission status bits for each service can be attached to B-TMSI. If a service is included in the page, the multi-services bit that corresponds to this service is set to “1”, otherwise, it is set to “0” (as illustrated in the example Service Table 500 of FIG. 5).

The re-transmission mechanism in B-TMSI will be described in further detail below. On the network side, if a broadcast page is sent to re-transmit a particular service, if the page is not sent for a service, and/or if the service is not supported in that location area, then the bit that corresponds to that service is set to “0”. If the page is sent with a new service transmission, the bit that corresponds to that service is set to “1”. When the mobile device decodes those bits, the mobile device can decide whether the page received has a new broadcast page message or a re-transmit to an existing message. This is a useful mechanism for the multi-services nature of the page. This mechanism can also be utilized if the mobile device misses (e.g., does not receive) some of the pages due to fading or channel conditions or due to other reasons. The priority of the service can indicate to the mobile device which service can have the high priority to be received among the multiple services sent in the page.

If network sends the PagingType1 message for voice or data calls, Pr-TMSI for the intended mobile device is included in the page and not the B-TMSI. If the mobile device does not detect any energy on B-PI, then the mobile device realizes that this is not a broadcast service page, and therefore, the mobile device can try to match the IMSI sent in PagingType1 with Pr-TMSI.

In accordance with some aspects, a mechanism to control the re-transmission of the Multi-Service pages is provided. A mobile device might miss a broadcast page due to fading (or due to other reasons). If a network is transmitting multiple pages spaced in time (e.g., DRX cycles), the re-transmission mechanism can notify the mobile device as to which service(s) sent in the page is re-transmitted and which service(s) is newly transmitted. The network can convey multiple messages for the same service, each message corresponding to a new transmission. In accordance with some aspects, the network might also decide to re-transmit some of the messages for which not all users have responded. This mechanism can enable the mobile device to discard the already received messages and process the new messages, thus conserving system resources. In the case of urgent messages, the network can require a re-transmission of the same service for confirmation. In this case, the user (e.g., mobile device) should not discard the re-transmission that was ordered by the network.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement the methodologies described herein. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

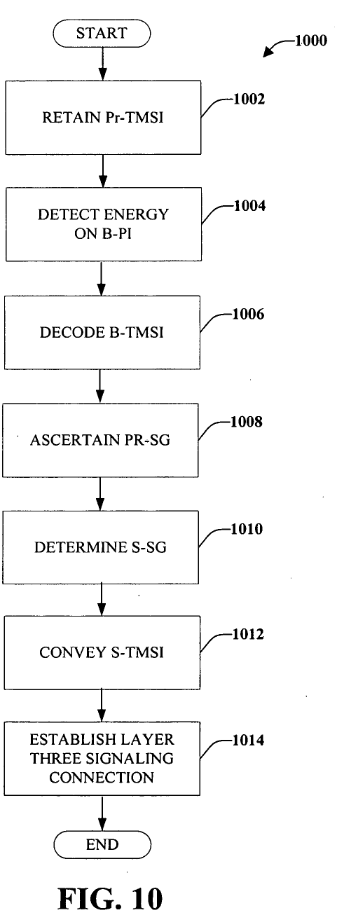

FIG. 10 illustrates a method 1000 for receiving a multiple location based-services page transmitted to a multitude of users. Method 1000 starts, at 1002, where a Primary Temporary Mobile Station Identity (Pr-TMSI) is received. The Pr-TMSI can be received when a device moves into a new location area. The Pr-TMSI includes a services group, which identifies the services that are supported by both the network and the mobile device. The Pr-TMSI also includes a unique identifier of the mobile device. The Pr-TMSI can be retained in memory.

At 1004, energy is detected on a Broadcast Paging Indicator (B-PI). The energy indicates that there is a page message available. If the B-PI does not contain energy, the message is not a broadcast message. In accordance with some aspects, the energy on the Broadcast Paging Indicator can be detected in an idle mode.

A Broadcast TMSI (B-TMSI) included in the page message is decoded, at 1006. The B-TMSI includes a group of services that indicates one or more services are available (e.g., there is a message related to these services that are to be conveyed to mobile devices in the area). The B-TMSI also includes retransmission status bits that indicate whether the service message being transmitted is a new message or a retransmitted message. If a retransmitted page message is detected, the retransmitted page message can be ignored in order to mitigate receipt of duplicate broadcast messages.

At 1008, a Primary Services Group (Pr-SG) is ascertained as a function of a first portion of the Pr-TMSI and services enabled. The services can be selectively enabled or disabled by a user through interaction with a User Interface. For example, the user interface can include a menu that allows the user to enable/disable one or more services.

A secondary Services Group (S-SG) is determined in an iterative manner, at 1010. The S-SG can be determined as function of the Pr-SG, the group of services, the retransmission status bits, and a highest priority service received for a first time. For example, if the highest priority service has already been received, the next highest priority service (that has not already been received) is utilized to determine the Pr-SG. Initially, the S-SG is set to be equal to Pr-SG.

Determining the S-SG can include bitwise ANDing Multi-Service bits in the B-TMSI with services enabled in the Pr-TMSI to obtain a first result. The retransmission status bits in the B-TMSI are bitwise ORed with the S-SG to obtain a second result. Then the first result is bitwise ANDed with the second result to calculate the S-SG.

A bit corresponding to the service to which information is to be received is set to “1” (e.g., identifier) and the S-SG is included in a Secondary TMSI (S-TMSI). The S-TMSI is conveyed to the network, at 1012. The S-TMSI also includes the identifier of the mobile device. A layer three signaling connection (e.g., RRC connection) is established with the network, at 1014, and messages related to the service identified (e.g., set to “1”) in the S-TMSI are exchanged with the network.

After the messages related to the service are exchanged, the bit corresponding to the service is toggled to “0”. Thus, the bit corresponding to the service contained in the S-SG is toggled to “0” to override the S-SG when the broadcast message is exchanged successfully between a transmitter and a receiver. In accordance with some aspects, one or more page messages carried on shared channels are decoded in connected mode after successfully decoding the Broadcast Paging Indicator.

According to some aspects, the Pr-TMSI is assigned in a layer three message page. In this aspect, a priorities of services included in the Pr-TMSI is read and the priorities of services are saved for later use when calculating the S-SG.

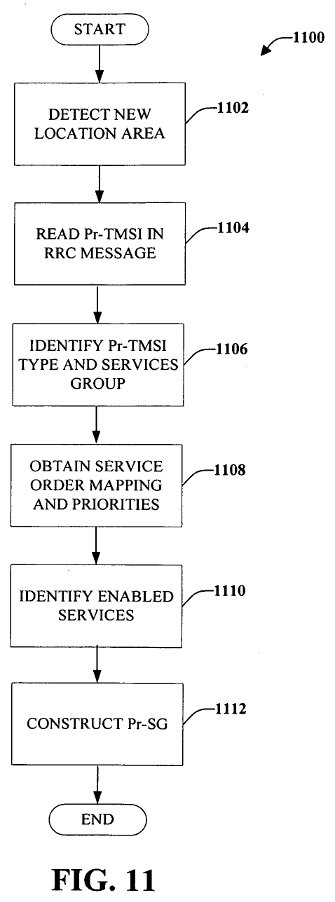

FIG. 11 illustrates a method 1100 for receiving a new Pr-TMSI from a network after detecting a new location area. As mobile devices are operated, the devices can be moved to different geographic areas (e.g., between cities, between states, and so forth). As a device is moved and is no longer in the service area of its HLR, the device obtains service from a VLR by obtaining information related to the VLR.

At 1102, a new location area is detected. Prior to detecting the new location, the device can be in a Discontinuous Reception (DRX) cycle. During the DRX cycle, the device user is not utilizing the device (e.g., not making phone calls or not performing other functions with the device) and the device can enter an “idle” state (which can also be referred to by other terminology). Entering this idle state can conserve battery power as well as other system resources. During the DRX cycle, the network (e.g., base station) is sending information to the devices (e.g., periodically) within its serving area. The detection of the location area with reference to method 1100 is after the device exits the idle state (e.g., wakes up), such as when the device user begins to initiate a call or perform other functions with the device and/or when there is incoming data intended for reception by the mobile device.

To detect the new location, at 1102, the device can reselect a new serving cell. For example, if the mobile device is in an idle state or is in a power off mode, when the device is powered back on (or exits the idle state), the device can detect its location and/or to which network the mobile device is closer and/or to which network the mobile device has a better radio link. There should only be one radio link or connection with a network since the device can only transfer information with a single base station (e.g., not multiple base stations). In accordance with some aspects, the mobile device can select a new serving cell if a better radio link can be established with that serving cell. Thus, there can be a measurement performed at the mobile device to determine to which base station the mobile device should be connected. If the mobile device wakes up and determines that there is a better serving cell, the device can move to that serving cell (e.g., handoff, establish a link).

A Primary-TMSI (Pr-TMSI) in an RRC message, for example, is read, at 1104. To read the Pr-TMSI, the left-most two bits can be read to identify the Pr-TMSI Type that has been assigned to the mobile device. A Pr-TMSI Type “1” is assigned to a mobile device if there are no services offered in the location, if the mobile device does not support broadcast services, or combinations thereof. If Pr-TMSI Type “1” is assigned, the mobile device takes no further action. If the mobile device is assigned a Pr-TMSI Type “2”, the next ten bits are read, starting from bit 29, for example. If a Pr-TMSI Type “3 is assigned, the next six bits are read, starting from bit 29, for example.

At 1106, the PR-TMSI Type and Service Group (SG) are determined. The Service Group (SG) assigned can be retained by the mobile device (e.g., in a computer-readable storage media, memory, and the like). The SG can be assigned in bits 29 to 20 for Pr-TMSI Type “2” and in bits 29 to 23 for Pr-TMSI Type “3”, for example. At 1108, Services Order Mapping and Priorities are obtained.

The mobile device identifies which services are enabled, at 1110. The services enabled can be identified by reviewing the user's User Interface, which are part of the SG transmitted in the Pr-TMSI. This identification can be performed by the higher layers. Based on the results, the mobile device constructs a new Services Group (SG), referred to as a Primary SG (Pr-SG), at 1112. In accordance with some aspects, all services might be enabled on the mobile device (e.g., the user has not disabled any services) and the mobile device can be assigned to a Service Group with the same services. In this situation, the SG is the same as Pr-SG. In accordance with some aspects, Pr-SG is initially copied to S-SG. The mobile device can enter an idle state (e.g., go to sleep) after updating a location and/or a routing area or the mobile device can continue with the method detailed in the following figure. The information obtained can be retained in a storage medium (e.g., computer readable storage media, memory, and the like).

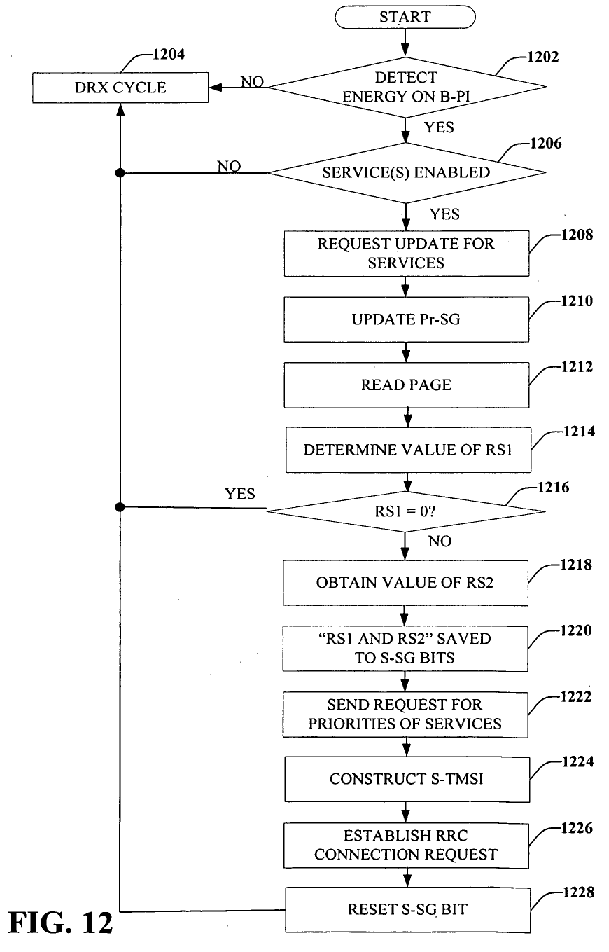

FIG. 12 illustrates a method 1200 for receiving a multi-services, multi-user page. Method 1200 can be utilized to identify that a received page is intended for the receiving device. Additionally, method 1200 can mitigate the receiving device from receiving duplicate messages in the cases where the network sends the page multiple times.

If the mobile device is not moving to a new serving cell and/or after moving to the new serving cell (as described in FIG. 11), the PICH can be decoded. Thus, the mobile device ascertains if there is an incoming page from the network. In accordance with some aspects, the page is received before establishing an incoming call (e.g., a call intended for mobile device). If there is an incoming page from the network, the energy on a Broadcast Paging Indicator Channel (PICH) is checked for energy, which indicates that the page is intended for the mobile device and the page is decoded. The mobile device can decode the PICH in each DRX cycle when the device is in idle mode. If energy is detected on PI bits and no energy is detected on B-PI bits in PICH, the mobile device can decide that the paging message sent is not intended for a broadcast service.

Method 1200 starts, at 1202 when a determination is made whether energy is detected on B-PI. Energy on B-PI indicates that the paging message is intended for a broadcast service. If energy is not detected on B-PI (“NO”), the Page is read utilizing a Pr-TMSI, and the device can enter a DRX Cycle, at 1204. The energy on a Broadcast Paging Indicator can be detected in an idle mode and/or a connected mode. If detected in connected mode, after successfully decoding the Broadcast Paging Indicator, one or more broadcast messages carried on shared channels can be decoded.

If energy is detected on B-PI (“YES”), method 1200 continues at 1206, where a determination is made whether at least one service is enabled on the mobile device. In accordance with some aspects, the user is provided an option to disable (e.g., turn off) all or a subset of services. If no services are enabled (“NO”), (e.g., the user does not want to receive any message for the services subscribed to), and energy is detected on PI bits and on B-PI bits in PICH, then the mobile device can safely ignore decoding SCCPCH for the page message. The mobile device can enter a DRX Cycle at 1204.

If at least one service is enabled (“YES”), such as through interaction with a User Interface, at 1208 an update from Higher Layers for services enabled in the User Interface is requested. Based on the services enabled by the user (as determined at 1206) and a Services Group included in a Pr-TMSI sent by the network in response to the request (e.g., sent in the page message), the Pr-SG is updated, at 1210.

At 1212, the page is read and a B-TMSI is obtained. In accordance with some aspects, a Secondary Common Control Physical Channel (SCCPCH) is decoded to read the page to identify the broadcast message sent. The B-TMSI sent in a paging type1 message is decoded. The B-TMSI type is identified from the left-most two bits.

A secondary services group (S-SG) is calculated as a function of the Pr-SG, the group of services, the retransmission status bits, and a highest priority service (received for a first time). The S-SG can be determined as a function of a bitwise operation. To perform the bitwise operation, the Multi-Service bits in the B-TMSI are ANDed (logically AND (&) the 0 bits and the 1 bits) with Pr-SG bits, at 1214, to determine a first result (RS1). If the first result (RS1) is “all 0s” (e.g., RS1=0), then method 1200 continues at 1104 and the DRX cycle is entered. When the results are “all 0s” (e.g., RS1=0) then either the user turned off all services though the User Interface, the user is not assigned services sent in the page, and/or the user is not subscribed to service sent in the page.

If the first result (RS1) does not equal zero (“NO”), at 1118, the re-transmission status bits in B-TMSI are read and bit ORed (∥) with the S-SG bits, to obtain a second value (RS2). At 1220, first value (RS1) (e.g., the mobile device bit) is ANDed (&) with the second value (RS2) and the result saved in the S-SG bits (e.g., the secondary services group value).

A request for an update from Higher Layers for priorities of services with bit “1” in S-SG is sent, at 1222. A S-TMSI that includes the S-SG is constructed for services with the highest priority, at 1224. The mobile device establishes a connection request (e.g., RRC connection request), at 1226, using S-TMSI with the SI of the sufficient service. The remaining bits other than SI in S-TMSI can be identical to those in Pr-TMSI. Upon receiving a service request release (e.g., an RRC connection release), the bit in S-SG corresponding to the service for the message received (e.g., that established RRC connection to construct a new S-SG) is reset, at 1228. Method 1200 continues, at 1204, where a DRX cycle is entered.

Thus, method 1200 allows the mobile device to identify that the page received is intended for the mobile device. In addition, method 1200 can mitigate the mobile device from receiving an already received message in the cases where the network sends the page multiple times. For example, in accordance with some aspects, a re-transmitted paging message can be detected. If the paging message has already been received, the re-transmission can be safety ignored in order to mitigate receipt of duplicate broadcast messages.

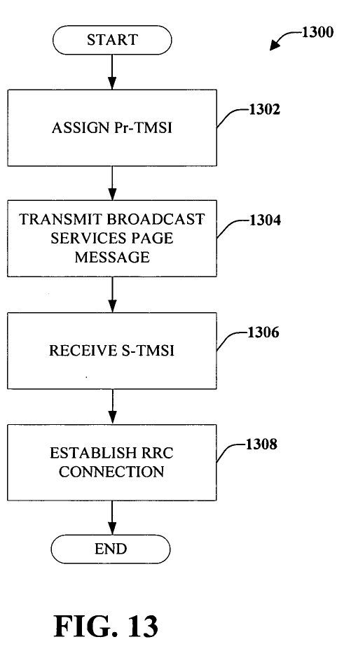

FIG. 13 illustrates a method 1300 for transmitting a multi-services, multi-user page in accordance to one or more aspects presented herein. At 1302, a Primary Temporary Mobile Station Identity (Pr-TMSI) is assigned to a mobile device. The Pr-TMSI includes a device identifier, unique for the mobile device, and a Service Group (SG). The Services Group can be included in a Service Table that can be generated based on the services that the network supports in a specific area (e.g., geographic location). The Services Group (SG) is assigned to a mobile device as a function of the services to which the mobile device has subscribed. In accordance with some aspects, a mobile device can be assigned to a Services Group in some locations according to which services the network supports in that location. For example, a mobile device might support a certain service, which the network does not offer. According to some aspects, Services Groups can be assigned to a multitude of different mobile devices.

The Pr-TMSI can be assigned at substantially the same time as a mobile device enters an area serviced by the network. In accordance with some aspects, the Pr-TMSI is assigned in layer three signaling messages (e.g., RRC signaling messages). The Pr-TMSI can include a Services Group for services to which the mobile device subscribes. There can be at least three different types of Pr-TMSIs, which include a Pr-TMSI Type 1, a Pr-TMSI Type 2, and a Pr-TMSI Type 3. For example, a Pr-TMSI Type 1 can be assigned if there are no services assigned to the mobile device. A Pr-TMSI Type 2 or Type 3 can be assigned if broadcast messages can be assigned to the mobile device.

The Pr-TMSI can also include priority for each service. The priority can be different in each location area depending on which services are supported by the network. The mobile device and network generally do not have an ordered list of services common on both sides until set. The network has the ability to identify which services are supported on both the mobile device and the location area serving the mobile device. The order of the services can be utilized to construct a Services Table. In addition, this list of services can be mapped one to one at the mobile device side. Therefore, in the same message (e.g., RRC message) in which the network assigns the Pr-TMSI to the mobile device, the mapping information of services can be sent to map a particular service at the mobile device to the particular service in that location. The priority might be different in each location area depending on which service the network supports.

At 1304, a broadcast services page message that includes a first Broadcast TMSI (B-TMSI) is transmitted to a multitude of mobile devices, including the mobile device assigned the Pr-TMSI. The broadcast service page can be a multi-user/multi-services page. The B-TMSI can include multiple services offered by the network (e.g., supported in that location) and for which a message is available (e.g., there is a message that needs to be transmitted). Also included in the B-TMSI are retransmission status bits that indicate whether the message for each service is a new message or a retransmitted message.

In accordance with some aspects, the broadcast service page can be selectively retransmitted, depending on the urgency/importance level of page and/or based on other criteria. An indication can be provided that indicates that the retransmitted broadcast services page is a new message or a retransmitted message. Additionally or alternatively, the broadcast services page can be carried on one or more shared channels in a connected/dedicated mode.

A Paging Indicator Channel (PICH) can be utilized to distinguish between at least two types of pages, in accordance with some aspects. This can involve utilizing the reserved bits on PICH to signal a different service type. When a broadcast service page is transmitted, all Paging Indicators (PI) in the PICH can be set to “all 1s” in addition to setting the remaining bits (e.g., 12 bits) in PICH (Broadcast Page Indicator, B-PI) to “all 1s”. However, if the page is intended for a specific device (e.g., data call, voice call, and so forth), the B-PI bits can be set to “all 0s”.

In accordance with some aspects, a B-TMSI is attached to a layer three paging message (e.g., Paging Type 1 message). The B-TMSI enables multiple services to be transmitted in the same page. In addition, re-transmission status bits for each service can be attached to the B-TMSI.

At 1306, a secondary TMSI (S-TMSI) is received. The S-TMSI includes the identity of the device sending the S-TMSI and the service to which the device is replying (e.g., the service currently being negotiated). The S-TMSI can be utilized by both the network and the mobile device to establish, at 1308, an layer three signaling message (e.g., RRC connection request, RRC connection setup, and so forth) and to transmit the service currently under negotiation. The S-TMSI is only used after the mobile device receives the broadcast page with a service (e.g., only when B-PI bits are all set to all “1”s). Service Identifier (SI) attached in S-TMSI indicates to the network the service to which mobile device is responding. The remaining bits can be used by network to identify the mobile device.

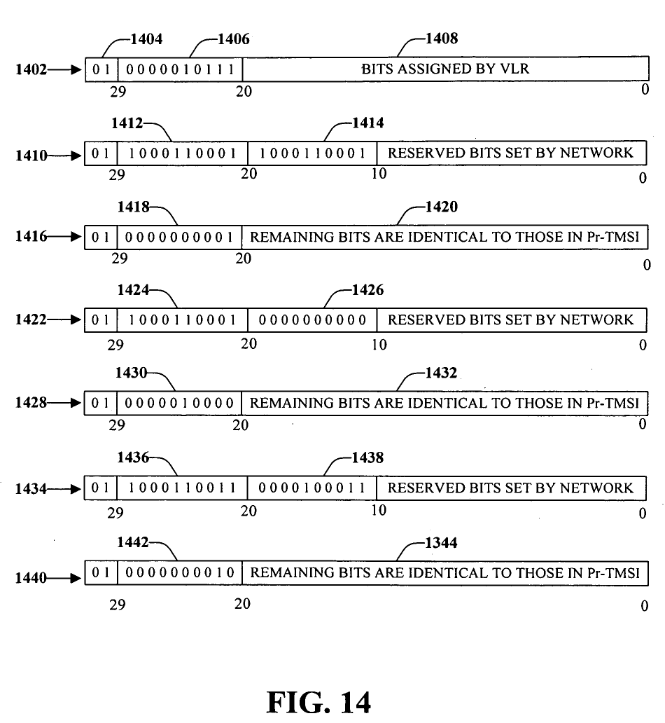

To fully appreciate the disclosed aspects, FIG. 14 illustrates an example of a multi-user/multi-service broadcast paging. At substantially the same time as a mobile device enters a new location area, the network can assign a Pr-TMSI 1402 to the mobile device. The first portion of the Pr-TMSI 1302 indicates the Pr-TMSI type 1404. In this example, the Pr-TMSI type 1404 is indicated by “0 1”. Also included in the Pr-TMSI 1302 is a services group (SG) 1406 (e.g., bits 29 to 20), which indicates the services that are supported by the network in the area where the mobile device is located (“0 0 0 0 0 1 0 1 1 1”). The remaining bits 1408 (e.g., bit 20 to bit 0) is the unique identifier of the mobile device. These bits 1408 can be assigned by a VLR.

At this point, the Pr-TMSI information has been previously sent to the mobile device and saved (e.g., in memory). For this example, it is assumed that the user has enabled all services in the Services Group from a user interface menu (e.g., no services are disabled). Since all services are enabled, the Pr-SG is the same as the SG. Thus, Pr-SG and SG are the same (“0 0 0 0 0 1 0 1 1 1”).

The mobile device decodes PICH and detects energy on PI and B-PI. This energy indicates that there is a broadcast message. The mobile device decodes SCCPCH and reads (decodes) a paging message (e.g., PagingType1 message) that includes a B-TMSI 1410. The paging message is a broadcast message sent that includes multi-services. The B-TMSI 1410 includes the services 1412 that the network is transmitting to all user devices in the area. The other portion 1414 (e.g., bits 20 to 10) of the B-TMSI 1410 includes indicate whether this is a new transmission or a retransmission.

The mobile device bitwise ANDs (&s) the first part of the Pr-TMSI 1306 (“0 0 0 0 0 1 0 1 1 1”) and the first part of the B-TMSI 1412 (“1 0 0 0 1 1 0 0 0 1”) to obtain a first result (RS1). Thus, the device is looking at all the broadcast messages services sent 1412 and ADDing those services with all the services that are enabled on the device. This bitwise AND operation filters the results since the services that are not enabled on the device are ignored. The bitwise AND operation is illustrated below:
1 0 0 0 1 1 0 0 0 1
&
0 0 0 0 0 1 0 1 1 1
RS1=0 0 0 0 0 1 0 0 0 1

A second operation is performed by the mobile device to bitwise OR ( ) the retransmission status bits 1414 (“1 0 0 0 1 1 0 0 0 1”) of B-TMSI 1410 with the first portion of the Pr-TMSI 1406 to obtain a second result (RS2), as per the following:

$$\begin{matrix}1 & 0 & 0 & 0 & 1 & 1 & 0 & 0 & 0 & 1 \\ & & & & \vert \vert & & & & & \\ 0 & 0 & 0 & 0 & 0 & 1 & 0 & 1 & 1 & 1\end{matrix}$$

$$RS 2 = \begin{matrix}1 & 0 & 0 & 0 & 1 & 1 & 0 & 1 & 1 & 1\end{matrix}$$

The mobile device performs another bitwise operation (AND (&)) to combine the first result (RS1) and the second result (RS2) as per the following:
RS1=0 0 0 0 0 1 0 0 0 1
&
RS2=1 0 0 0 1 1 0 1 1 1
S-SG=0 0 0 0 0 1 0 0 0 1

The filtered result is saved in S-SG bits. The S-SG are the services to which the mobile device responds and indicates the services that are supported by both the network and are enabled in the mobile device. In this example, services A and E (as determined by the location of the “1”s in the S-SG) are the services to which the mobile device responds. For example, the first rightmost location has bit “1” in it, which corresponds to service “A” and the fifth rightmost location has bit “1”, which corresponds with service “E”.

For this example, it is assumed that service “A” is a higher priority than service “E”. The priority information is assigned by the network in the Pr-TMSI, which was previously received and retained by the mobile device. The mobile device constructs a Secondary TMSI (S-TMSI) 1416 and sends only the first service (service “A”) in the S-TMSI 1416. The first portion 1418 of the S-TMSI 1416 is constructed based on the results of the bitwise operation (S-SG) and the priority of services (as was indicated in the Pr-TMSI). This portion 1418 indicates to the network which services the mobile device is replying to since the network can be transmitting multiple services, some of which are not enabled at the mobile device. In this example, the mobile device is indicating that it is replying to service “A”, as indicated by the “1” in the first rightmost bit in the first portion 1418 of the S-TMSI 1416. The remaining portion 1420 of the S-TMSI 1416 is the same as the second part 1408 of the Pr-TMSI 1402 (e.g., the unique identifier of the mobile device).

The mobile device establishes a RRC connection request utilizing the S-TMSI that includes the appropriate service indicator (SI) bit of the sufficient service (e.g., the bit corresponding to service “A” is set to “1”). The network can utilize the same service identifier in a RRC connection response. After this, messages can be exchanged in connected mode.

After the mobile device receives the message contents for Service “A” and the RRC connection is released, the mobile device toggles the bit corresponding to Service “A” in the S-SG to “0”, which overrides the S-SG. The bit for the remaining service “E” is kept as a “1” because the mobile device has not yet replied to this service. Thus the S-SG is now:
S-SG=0 0 0 0 0 1 0 0 0 0

The mobile device goes to sleep (e.g., enters DRX cycle), decodes PICH again and discovers energy on PI and B-PI, which indicates that there are more services to be transmitted by the network. The mobile device decodes SCCPCH and reads a B-TMSI 1422 (e.g., PagingType1 message) to decode the B-PI to determine which services are being transmitted from the network. From the B-TMSI 1422, the mobile device discovers that bit 5 corresponding to service “E” is set to “1”. It should be noted that the network is re-transmitting all services 1424 in this page 1422 as indicated in the retransmission status bits 1426.

At this point, the Pr-SG is equal to “0 0 0 0 0 1 0 1 1 1” and the S-SG is equal to “0 0 0 0 0 1 0 0 0 0” (as described above), which indicates that there is still a service (service “E”) which has not been sent. If the S-SG bits were all set to zero, it would indicate that there are no more services to which the device should reply. The mobile device bitwise ANDs (&s) the Pr-SG (which was previously saved) with B-TMSI multi-service bits 1424 to obtain a new first result (RS1), as indicated below:
1 0 0 0 1 1 0 0 0 1
&
Pr-SG=0 0 0 0 0 1 0 1 1 1
RS1=0 0 0 0 0 1 0 0 0 1

The mobile device bitwise ORs (∥'s) the S-SG with the re-transmission status bits 1426 of the B-TMSI 1422 to obtain a new second result (RS2), as indicated below:

$$\begin{matrix}0 & 0 & 0 & 0 & 0 & 0 & 0 & 0 & 0 & 0 \\ & & & & & \vert \vert & & & & \end{matrix}$$

$$S \text{-} SG = \begin{matrix}0 & 0 & 0 & 0 & 0 & 1 & 0 & 0 & 0 & 0\end{matrix}$$

$$RS 2 = \begin{matrix}0 & 0 & 0 & 0 & 0 & 1 & 0 & 0 & 0 & 0\end{matrix}$$

The result of the above operation is that the fifth rightmost bit (corresponding to service “E”) is still enabled and, therefore, the network still wants to transmit this service to the mobile device. The mobile device bitwise ANDs (&s) the first result (RS1) with the second result (RS2) and saves the results in S-SG bits 1418:
RS1=0 0 0 0 0 1 0 0 0 1
&
RS2=0 0 0 0 0 1 0 0 0 0
S-SG=0 0 0 0 0 1 0 0 0 0

A S-TMSI 1428 is constructed that include S-SG 1430 (the result of the above operation) to indicate to the network that the mobile device is replying to the indicated service (service “E” in this example). The remaining bits 1432 are the unique identifier of the mobile device. The mobile device then establishes a RRC connection request using the S-TMSI 1428 with the SI of the sufficient service (e.g., service “E”), as indicated at 1430).

After the mobile device receives the message contents for Service “E”, and RRC connection is released, the mobile device toggles the bit corresponding to Service “E” in S-SG to “0”:
S-SG=0 0 0 0 0 0 0 0 0 0

The mobile device then goes to sleep until PICH is decoded again and energy is found on PI and B-PI. When energy is found on PI and B-PI, the mobile device decodes SCCPCH and reads the paging message that includes the B-TMSI illustrated at 1434. At this point the Pr-SG=0 0 0 0 0 1 0 1 1 1 and the S-SG=0 0 0 0 0 0 0 0 0 0 (since the mobile device has replied to all services). The services being transmitted by the network, at 1436, are services “A”, “B”, “E”, “F”, and “J”, as indicated by the bits set to “1”. The retransmission status bits 1438 indicate that services “E” and “J” are transmitted (e.g., the corresponding bits are set to “0”) and that services “A”, “B”, and “F” are newly transmitted (e.g., the corresponding bits are set to “1”) in this page 1434.

The mobile device bitwise ANDs (&s) the services transmitted 1436 with the Pr-SG to obtain another new first result (RS1), as indicated below:
1 0 0 0 1 1 0 0 1 1
&
Pr-SG=0 0 0 0 0 1 0 1 1 1
RS1=0 0 0 0 0 1 0 0 1 1

The mobile device bitwise ORs (∥'s) the S-SG with the re-transmission status bits 1438 of B-TMSI 1430 to obtain a new second result (RS2), as indicated below:

$$\begin{matrix}0 & 0 & 0 & 0 & 1 & 0 & 0 & 0 & 1 & 1 \\ & & & & \vert \vert & & & & & \end{matrix}$$

$$S \text{-} SG = \begin{matrix}0 & 0 & 0 & 0 & 0 & 0 & 0 & 0 & 0 & 0\end{matrix}$$

$$RS 2 = \begin{matrix}0 & 0 & 0 & 0 & 1 & 0 & 0 & 0 & 1 & 1\end{matrix}$$

The mobile device bit ANDs (&s) the new first result (RS1) with the new second result (RS2) and saves the results in S-SG bits:
RS1=0 0 0 0 0 1 0 0 1 1
&
RS2=0 0 0 0 1 0 0 0 1 1
S-SG=0 0 0 0 0 0 0 0 1 1

As of now, services “A” and “B” are supported by both the network and the mobile device by serving cell (as indicated by the corresponding bits in the S-SG that are set to “1). It should be noted that service “E” is also supported by both the mobile device and the network. However, because this service is re-transmitted in this page and the mobile device has already received this message in the previous round, the mobile device ignores this service in the page.

For this example, it is assumed that service “B” is a higher priority then service “A”, as specified by the network in the Pr-TMSI, which was previously received. The mobile device establishes a RRC connection request using S-TMSI 1440 with the SI of the sufficient service (service “B”) set to “1”, as illustrated at 1442. The remaining bits 1444 are the unique identifier of the mobile device.

After the mobile device receives the message contents for Service “B”, and the RRC connection is released, the mobile device toggles the bit corresponding to Service B in S-SG to “0”:
S-SG=0 0 0 0 0 0 0 0 0 1

The process can continue with the mobile device going to sleep until energy is detected on the B-PI bit and a new service is to be received (e.g., Service “A” in the above example).

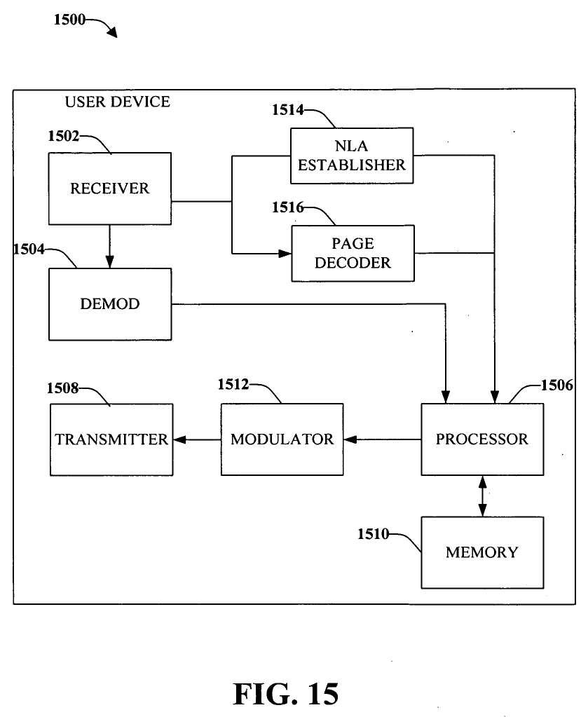

With reference now to FIG. 15, illustrated is a system 1500 that facilitates receiving a multi-user/multi-services page in accordance with one or more of the disclosed aspects. System 1500 can reside in a user device. System 1500 comprises a receiver 1502 that can receive a signal from, for example, a receiver antenna. The receiver 1502 can perform typical actions thereon, such as filtering, amplifying, downconverting, etc. the received signal. The receiver 1502 can also digitize the conditioned signal to obtain samples. A demodulator 1504 can obtain received symbols for each symbol period, as well as provide received symbols to a processor 1506.

Processor 1506 can be a processor dedicated to analyzing information received by receiver component 1502 and/or generating information for transmission by a transmitter 1508. In addition or alternatively, processor 1506 can control one or more components of user device 1500, analyze information received by receiver 1502, generate information for transmission by transmitter 1508, and/or control one or more components of user device 1500. Processor 1506 may include a controller component capable of coordinating communications with additional user devices.

User device 1500 can additionally comprise memory 1508 operatively coupled to processor 1506 and that can store information related to coordinating communications and any other suitable information. Memory 1510 can additionally store protocols associated with sample rearrangement. It will be appreciated that the data store (e.g., memories) components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1508 of the subject systems and/or methods is intended to comprise, without being limited to, these and any other suitable types of memory. User device 1500 can further comprise a symbol modulator 1512 and a transmitter 1508 that transmits the modulated signal.

Receiver 1502 is further operatively coupled to a new location area NLA) establisher 1514 that detects a new location and gathers information in order to construct a primary services group (Pr-SG). Receiver 1502 is also operatively coupled to a page decoder 1516 that is configured to receive and decode a page that is intended for multiple users and that can include multiple services supported by the sending device.

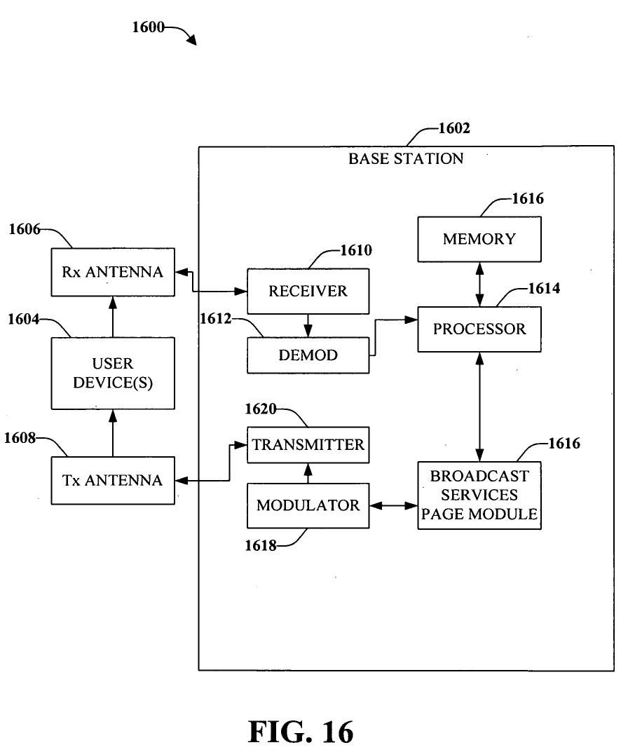

FIG. 16 is an illustration of a system 1600 that facilitates transmitting location based-services pages to multiple mobile devices in accordance with various aspects presented herein. System 1600 comprises a base station or access point 1602. As illustrated, base station 1602 receives signal(s) from one or more user devices 1604 by a receive antenna 1606, and transmits to the one or more user devices 1604 through a transmit antenna 1608.

Base station 1602 comprises a receiver 1610 that receives information from receive antenna 1606 and is operatively associated with a demodulator 1612 that demodulates received information. Demodulated symbols are analyzed by a processor 1614 that is coupled to a memory 1616 that stores information related to broadcast-multicast waveforms embedded in a unicast waveform. A modulator 1618 can multiplex the signal for transmission by a transmitter 1620 through transmit antenna 1608 to user devices 1604.

Processor 1614 is further coupled to a broadcast services page module 1616 that is configured to construct a broadcast services page that includes a B-TMSI. In accordance with some aspects, broadcast services page module 1616 can be configured to reply to a S-TMSI received from one or more mobile devices in accordance with the various aspects disclosed herein.

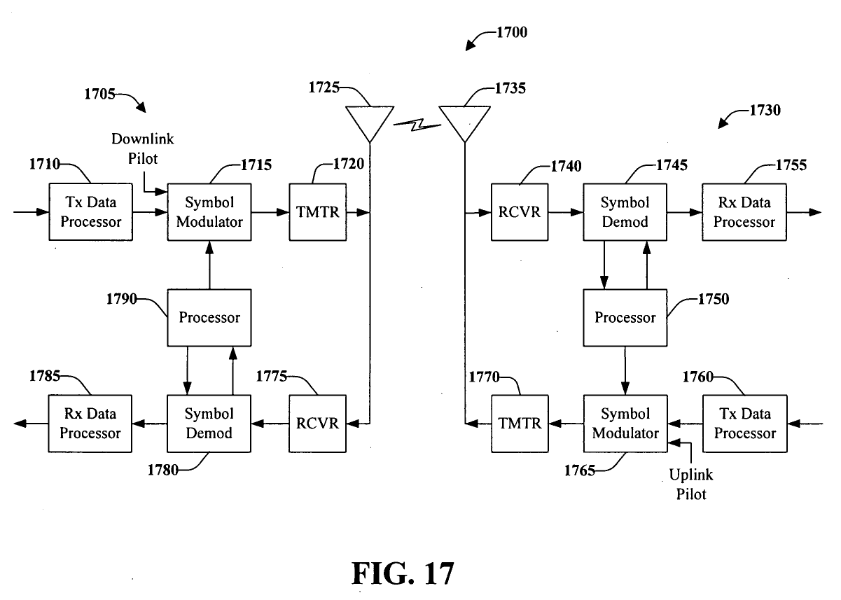

FIG. 17 illustrates an exemplary wireless communication system 1700. Wireless communication system 1700 depicts one base station and one terminal for sake of brevity. However, it is to be appreciated that system 1700 can include more than one base station or access point and/or more than one terminal or user device, wherein additional base stations and/or terminals can be substantially similar or different from the exemplary base station and terminal described below. In addition, it is to be appreciated that the base station and/or the terminal can employ the systems and/or methods described herein to facilitate wireless communication there between.

Referring now to FIG. 17, on a downlink, at access point 1705, a transmit (TX) data processor 1710 receives, formats, codes, interleaves, and modulates (or symbol maps) traffic data and provides modulation symbols (“data symbols”). A symbol modulator 1715 receives and processes the data symbols and pilot symbols and provides a stream of symbols. A symbol modulator 1715 multiplexes data and pilot symbols and obtains a set of N transmit symbols. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

A transmitter unit (TMTR) 1720 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1725 to the terminals. At terminal 1730, an antenna 1735 receives the downlink signal and provides a received signal to a receiver unit (RCVR) 1740. Receiver unit 1740 conditions (e.g., filters, amplifies, and frequency downconverts) the received signal and digitizes the conditioned signal to obtain samples. A symbol demodulator 1745 obtains Nreceived symbols and provides received pilot symbols to a processor 1750 for channel estimation. Symbol demodulator 1745 further receives a frequency response estimate for the downlink from processor 1750, performs data demodulation on the received data symbols to obtain data symbol estimates (which are estimates of the transmitted data symbols), and provides the data symbol estimates to an RX data processor 1755, which demodulates (i.e., symbol demaps), deinterleaves, and decodes the data symbol estimates to recover the transmitted traffic data. The processing by symbol demodulator 1745 and RX data processor 1755 is complementary to the processing by symbol modulator 1715 and TX data processor 1710, respectively, at access point 1705.

On the uplink, a TX data processor 1760 processes traffic data and provides data symbols. A symbol modulator 1765 receives and multiplexes the data symbols with pilot symbols, performs modulation, and provides a stream of symbols. A transmitter unit 1770 then receives and processes the stream of symbols to generate an uplink signal, which is transmitted by the antenna 1735 to the access point 1705.

At access point 1705, the uplink signal from terminal 1730 is received by the antenna 1725 and processed by a receiver unit 1775 to obtain samples. A symbol demodulator 1780 then processes the samples and provides received pilot symbols and data symbol estimates for the uplink. An RX data processor 1785 processes the data symbol estimates to recover the traffic data transmitted by terminal 1730. A processor 1790 performs channel estimation for each active terminal transmitting on the uplink.

Processors 1790 and 1750 direct (e.g., control, coordinate, manage, . . . ) operation at access point 1705 and terminal 1730, respectively. Respective processors 1790 and 1750 can be associated with memory units (not shown) that store program codes and data. Processors 1790 and 1750 can also perform computations to derive frequency and impulse response estimates for the uplink and downlink, respectively.

For a multiple-access system (e.g., FDMA, OFDMA, CDMA, TDMA, and the like), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors 1790 and 1750.

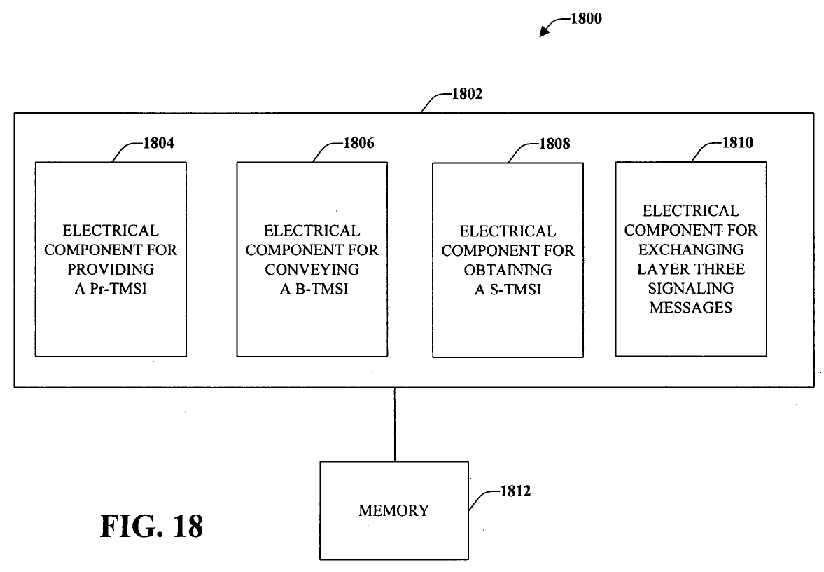

With reference to FIG. 18, illustrated is an example system 1800 that transmits a location based-services page to a multitude of users. System 1800 can reside at least partially within a base station. System 1800 is represented as including functional blocks, which may be functional blocks that represent functions implemented by a processor, software, or combination thereof (e.g., firmware).

System 1800 includes a logical grouping 1802 of electrical components that can act separately or in conjunction. Logical grouping 1802 includes an electrical component 1804 for providing to a first mobile device a Pr-TMSI that includes a device identifier and a Service Group (SG). Electrical component 1804 can assign a Pr-TMSI to more than one mobile device, wherein the device identifier included in each Pr-TMSI is unique for each mobile device.

Logical grouping 1802 also includes an electrical component 1806 for conveying a broadcast services page message to a multitude of mobile devices, including the first mobile device. Included in the broadcast services page message is a B-TMSI. The B-TMSI includes a group of services offered by the network (and available in the location area) and retransmission status bits that indicate whether a message corresponding to each service is a new transmission or a retransmission. For example, the B-TMSI can be retransmitted in a broadcast services page message and the retransmission status bits can indicate that it is a new message (if the network does not want the mobile device to ignore the retransmission). The broadcast services page message can be carried on one or more shared channels in a connected/dedicated mode.

Also included in logical grouping 1802 is an electrical component 1808 for obtaining a Secondary TMSI (S-TMSI) from one or more mobile devices. The S-TMSI includes an identifier of the device and an indication of the service to which the device is replying. The service included in the S-TMSI is a service that is under negotiation that is selected from the group of services included in the B-TMSI. The S-TMSI can be received as part of a layer three signaling message.

The Pr-TMSI can be one of a Pr-TMSI Type 1, a Pr-TMSI Type 2, or a Pr-TMSI Type 3. The Pr-TMSI can be a Pr-TMSI Type 1 if there are no services assigned to the mobile device. According to some aspects, the primary TMSI can be a Pr-TMSI Type 2 and a secondary TMSI is a S-TMSI Type 1. According to other aspects, the primary TMSI can be a Pr-TMSI Type 3 and a secondary TMSI can be a S-TMSI Type 2. The Pr-TMSI is a Type 2 or a Type 3 if broadcast messages can be assigned to the mobile device.

Based on the information received in the S-TMSI, an electrical component 1810 for exchanging layer three signaling messages with the first mobile device conveys the identified service (e.g., the service that is under negotiation) to the mobile device. For example, the identified service can be transmitted in an RRC connection with the first mobile device.

In accordance with some aspects, logical grouping 1802 can include an electrical component for prioritizing services included in the services group before generating the secondary TMSI and/or an electrical component for constructing a services tables as a function of services supported in each location. Additionally or alternatively, logical grouping 1802 can include an electrical component for assigning a Temporary Mobile Station Identity to a mobile device before assigning the mobile device to the services group.

Further, according to some aspects, logical grouping 1802 can include an electrical component for utilizing a Paging Indicator Channel (PICH) to distinguish between at least two types of pages (e.g., a unicast message, a broadcast message). If a broadcast message is to be transmitted, Broadcast Paging Indicator (B-PI) bits in the PICH are set to “1”. If a unicast message is to be sent, the B-PI bits are set to “0”. In accordance with some aspects, logical grouping 1802 can include an electrical component for attaching a B-TMSI to a layer three paging message.

In accordance with some aspects, logical grouping 1802 can include an electrical component for transmitting a second broadcast services page message that includes a second B-TMSI. The second broadcast services page message is sent to a multitude of mobile devices that include the first mobile device. The second B-TMSI can include retransmission status bits that indicate if the transmission is a new transmission or a retransmission. Logical grouping 1802 can also include an electrical component for receiving a second S-TMSI that identifies a second service that is under negotiation and an electrical component for exchanging layer three signaling messages with the first mobile device to convey the second service.

Additionally, system 1800 can include a memory 1812 that retains instructions for executing functions associated with electrical components 1804, 1806, 1808 and 1810 or other components. While shown as being external to memory 1812, it is to be understood that one or more of electrical components 1804, 1806, 1808 and 1810 can exist within memory 1812.

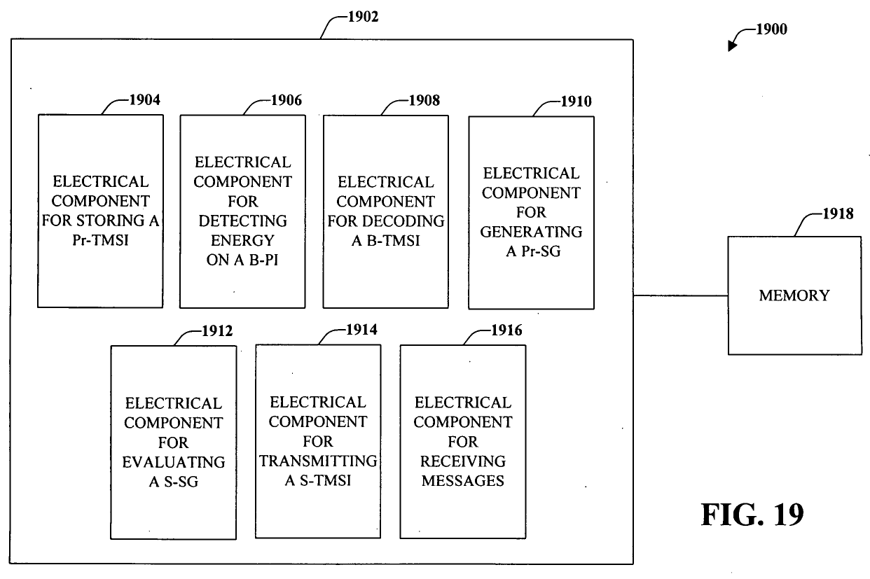

FIG. 19 illustrates an example system 1900 that receives a multiple location based-services page transmitted to a multitude of users. System 1900 can reside at least partially within a mobile device and is represented as including functional blocks, which may be functional blocks that represent functions implemented by a processor, software, or combination thereof (e.g., firmware).

Included in system 1900 is a logical grouping 1902 of electrical components that can act separately or in conjunction. Logical grouping 1902 includes an electrical component 1904 for storing A Pr-TMSI. The Pr-TMSI can be received upon entering a new location area and can be stored in a memory, for example. Also included is an electrical component 1906 for detecting energy on a Broadcast Paging Indicator (B-PI). The energy indicates a page message. The energy can be detected in an idle mode and/or in a connected mode. Decoding one or more broadcast messages carried on shared channels in connected mode is performed after successfully decoding the Broadcast Paging Indicator. No energy on the B-PI indicates that there is no page message available.

Logical grouping 1902 also includes an electrical component 1908 for decoding a B-TMSI included in the page message. The B-TMSI includes retransmission status bits and a Pr-SG that indicates that one or more services are available. The B-TMSI also includes a group of services that indicate one or more services are available (e.g., services supported in that area and that are being sent in the page message).

Further, logical grouping 1902 includes an electrical component 1910 for generating a Primary Services Group (Pr-SG) as a function of a first portion of the Pr-TMSI and services enabled by the user though interaction with a User Interface menu. Also included is an electrical component 1912 for iteratively evaluating a secondary services group (S-SG) as a function of the Pr-SG, the group of services, the retransmission status bits, and a highest priority service received for a first time (e.g., the service was not previously received). The S-SG is initially set equal to Pr-SG.

Logical grouping 1902 also includes an electrical component 1914 for transmitting a secondary TMSI (S-TMSI) that includes the S-SG and an identifier of one of the services in the S-SG (e.g., the service currently being negotiated). Also included is an electrical component 1916 for receiving messages related to the service identified in the S-TMSI.

In accordance with some aspects, electrical component 1912 can perform a bitwise operation that can include determining a first result (RS1), obtaining a second result (RS2) if the value of the first result (RS1) is not equal to zero, and bitwise ANDing (&) the first result (RS1) with the second result (RS2). In accordance with this aspect, logical grouping 1902 includes an electrical component for bitwise ANDing (&) a Multi-Service bits in the B-TMSI with services enabled in the PR-SG to obtain the first result. Also includes is an electrical component for bitwise ORing (∥) the retransmission status bits in the B-TMSI with S-SG to obtain the second result. In accordance with some aspects, the second result is equal to zero if all services are turned off, the mobile device is not assigned services, the mobile device is not authorized to access services sent in the page, or combinations thereof. Logical grouping 1902 also includes an electrical component for bitwise ANDing (&) the first result with the second result to calculate the secondary services group.

In accordance with some aspects, logical grouping 1902 can include an electrical component for detecting a retransmitted paging message and an electrical component for ignoring the retransmitted paging messages to mitigate receipt of duplicate broadcast messages. A retransmitted paging message can be received with an indication that it is a new page (e.g., emergency situation). Such a re-transmitted paging message is treated as a new page.

Additionally or alternatively, logical grouping 1902 can include an electrical component for toggling a bit corresponding to the service contained in the S-SG to “0” to override the S-SG when the broadcast message is exchanged successfully between receiver and transmitter entities. In accordance with some aspects, the Pr-TMSI is assigned in a layer three message page. In according with this aspect, logical grouping 1902 includes an electrical component for reading a priorities of services included in the Pr-TMSI and an electrical component for saving the priorities of services for use to calculate the S-SG.

Additionally, system 1900 can include a memory 1918 that retains instructions for executing functions associated with electrical components 1904, 1906, 1908, 1910, 1912, 1914, and 1916 or other components. While shown as being external to memory 1918, it is to be understood that one or more of electrical components 1904, 1906, 1908, 1910, 1912, 1914, and 1916 can exist within memory 1916.

It is to be understood that the aspects described herein may be implemented by hardware, software, firmware or any combination thereof. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description of the claims is meant to be a “non-exclusive or”.

What is claimed is:

1. A method for transmitting a location based-services page to a plurality of users, comprising:
assigning to a first mobile device a Primary Temporary Mobile Station Identity (Pr-TMSI) that comprises a device identifier and a Service Group (SG);
transmitting to a plurality of mobile devices that include the first mobile device a broadcast services page message that includes a first Broadcast TMSI (B-TMSI), the B-TMSI comprises retransmission status bits and a group of services offered by a network;
receiving from the first mobile device a first secondary TMSI (S-TMSI) that includes the device identifier and an indication of one service that is under negotiation from the group of services; and
exchanging layer three signaling messages with the first mobile device to convey the one service that is under negotiation.

2. The method of claim 1, further comprising: utilizing a Paging Indicator Channel (PICH) to distinguish between at least two types of pages, wherein the Paging Indicator Channel (PICH) includes Broadcast Paging Indicator (B-PI) bits that are set to “1” for a broadcast message.

3. The method of claim 1, further comprising:
transmitting a second broadcast services page message that includes a second B-TMSI to the plurality of mobile devices, the second B-TMSI comprises retransmission status bits that indicate the services are a retransmission or a new transmission;
receiving a second S-TMSI from the first mobile device, the S-TMSI identifies a second service that is under negotiation; and
exchanging layer three signaling messages with the first mobile device to convey the second service.

4. The method of claim 1, wherein the retransmission status bits indicate whether the page message is a new transmission or a retransmission.

5. The method of claim 1, wherein the Pr-TMSI is a Pr-TMSI Type 1 if there are no services assigned to the first mobile device and the Pr-TMSI is a Type 2 or a Type 3 if broadcast messages can be assigned to the first mobile device.

6. The method of claim 1, wherein the first S-TMSI is received as part of a layer three signaling message.

7. The method of claim 1, further comprising: selectively retransmitting the broadcast services page message.

8. The method of claim 7, further comprising: indicating that the retransmitted broadcast services page is a new message.

9. The method of claim 1, wherein the broadcast services page message is carried on one or more shared channels in a connected/dedicated mode.

10. The method of claim 1, further comprising: attaching the B-TMSI to a layer three paging message.

11. The method of claim 1, further comprising: constructing a services table as a function of services supported in each location.

12. A wireless communications apparatus, comprising:
a memory that retains instructions related to assigning to a first mobile device a Primary Temporary Mobile Station Identity (Pr-TMSI) that comprises a device identifier and a Service Group (SG), transmitting to a plurality of mobile devices a broadcast services page message that includes a first Broadcast TMSI (B-TMSI), the B-TMSI comprises retransmission status bits and a group of services offered by a network, receiving from the first mobile device a first secondary TMSI (S-TMSI) that includes the device identifier and an indication of one service that is under negotiation from the group of services, and exchanging layer three signaling messages with the first mobile device to convey the one service that is under negotiation, wherein the plurality of mobile devices include the first mobile device; and
a processor, coupled to the memory, configured to execute the instructions retained in the memory.

13. The wireless communications apparatus of claim 12, wherein the memory further retains instructions related to utilizing a Paging Indicator Channel (PICH) to distinguish between at least two types of pages, and wherein the Paging Indicator Channel (PICH) includes Broadcast Paging Indicator (B-PI) bits that are set to “1” for a broadcast message.

14. The wireless communications apparatus of claim 12, wherein the memory further retains instructions related to:
transmitting a second broadcast services page message that includes a second B-TMSI to the plurality of mobile devices, wherein the second B-TMSI comprises retransmission status bits that indicate the services are a retransmission or a new transmission;
receiving a second S-TMSI from the first mobile device, wherein the S-TMSI identifies a second service that is under negotiation; and
exchanging layer three signaling messages with the first mobile device to convey the second service.

15. The wireless communications apparatus of claim 12, wherein the first S-TMSI is received as part of a layer three signaling message and the broadcast services page message is carried on one or more shared channels in a connected/dedicated mode.

16. A wireless communications apparatus that transmits a location based-services page, comprising:
means for providing to a first mobile device a Primary Temporary Mobile Station Identity (Pr-TMSI) that comprises a device identifier and a Service Group (SG);
means for conveying to a plurality of mobile devices that include the first mobile device a broadcast services page message that includes a first Broadcast TMSI (B-TMSI), the B-TMSI comprises retransmission status bits and a group of services offered by a network, wherein the retransmission status bits indicate whether the page message is a new transmission or a retransmission;
means for obtaining from the first mobile device a first secondary TMSI (S-TMSI) that includes the device identifier and an indication of one service that is under negotiation from the group of services; and
means for exchanging layer three signaling messages with the first mobile device to convey the one service that is under negotiation.

17. A computer program product, comprising:
a computer-readable medium comprising:
a first set of codes for causing a computer to provide to a first mobile device a Primary Temporary Mobile Station Identity (Pr-TMSI) that comprises a device identifier and a Service Group (SG);
a second set of codes for causing the computer to convey to a plurality of mobile devices that include the first mobile device a broadcast services page message that includes a first Broadcast TMSI (B-TMSI), the B-TMSI comprises retransmission status bits and a group of services offered by a network;
a third set of codes for causing the computer to obtain from the first mobile device a first secondary TMSI (S-TMSI) that includes the device identifier and an indication of one service that is under negotiation from the group of services; and
a fourth set of codes for causing the computer to exchange layer three signaling messages with the first mobile device to convey the one service that is under negotiation.

18. At least one processor configured to transmit a location based-services page to a plurality of users, comprising:
a first module for assigning to a first mobile device a Primary Temporary Mobile Station Identity (Pr-TMSI) that comprises a device identifier and a Service Group (SG);
a second module for utilizing a Paging Indicator Channel (PICH) to distinguish between at least two types of pages, wherein the Paging Indicator Channel (PICH) includes Broadcast Paging Indicator (B-PI) bits that are set to “1” for a broadcast message;
a third module for transmitting to a plurality of mobile devices that include the first mobile device a broadcast services page message that includes a first Broadcast TMSI (B-TMSI), the B-TMSI comprises retransmission status bits and a group of services offered by a network;
a fourth module for receiving from the first mobile device a first secondary TMSI (S-TMSI) that includes the device identifier and an indication of one service that is under negotiation from the group of services; and
a fifth module for exchanging layer three signaling messages with the first mobile device to convey the one service that is under negotiation.

19. A method for receiving a multiple location based-services page transmitted to a plurality of users, comprising:
retaining a Primary Temporary Mobile Station Identity (Pr-TMSI);
detecting energy on a Broadcast Paging Indicator (B-PI), wherein the energy indicates a page message;
decoding a Broadcast TMSI (B-TMSI) included in the page message, the B-TMSI comprises retransmission status bits and a group of services that indicates one or more services are available;
ascertaining a Primary Services Group (Pr-SG) as a function of a first portion of the Pr-TMSI and services enabled;
iteratively determining a secondary Services Group (S-SG) as a function of the Pr-SG, the group of services, the retransmission status bits, and a highest priority service received for a first time, wherein S-SG is initially set equal to Pr-SG;
conveying a Secondary TMSI (S-TMSI) that includes the S-SG and an identifier of one service included in the S-SG;
establishing a layer three signaling connection; and
exchanging messages related to the one service identified in the S-TMSI.

20. The method of claim 19, wherein iteratively determining the S-SG further comprises:
bitwise ANDing Multi-Service bits in the B-TMSI with services enabled in the Pr-SG to obtain a first result;
bitwise ORing the retransmission status bits in the B-TMSI with the S-SG to obtain a second result; and
bitwise ANDing the first result with the second result to calculate the secondary services group.

21. The method of claim 19, wherein the B-PI does not contain energy if the paging message is not a broadcast message.

22. The method of claim 19, further comprising: toggling a bit that corresponds to the service contained in the S-SG to “0” to override the S-SG when the broadcast message is exchanged successfully between receiver and transmitter entities.

23. The method of claim 19, further comprising:
detecting a retransmitted page message; and
ignoring the retransmitted page message to mitigate receipt of duplicate broadcast messages.

24. The method of claim 19, wherein the energy on the Broadcast Paging Indicator is detected in an idle mode.

25. The method of claim 19, further comprising: decoding one or more page messages carried on shared channels in connected mode after successfully decoding the Broadcast Paging Indicator.

26. The method of claim 19, wherein the Pr-TMSI is assigned in a layer three message page, the method further comprising:
reading a priorities of services included in the Pr-TMSI; and
saving the priorities of services for use to calculate the S-SG.

27. A wireless communications apparatus, comprising:
a memory that retains instructions related to retaining a Primary Temporary Mobile Station Identity (Pr-TMSI), detecting energy on a Broadcast Paging Indicator (B-PI), decoding a Broadcast TMSI (B-TMSI) included in the page message, the B-TMSI comprises retransmission status bits and a group of services that indicates one or more services are available, ascertaining a Primary Services Group (Pr-SG) as a function of a first portion of the Pr-TMSI and services enabled, iteratively determining a secondary Services Group (S-SG) as a function of the Pr-SG, the group of services, the retransmission status bits, and a highest priority service received for a first time, conveying a Secondary TMSI (S-TMSI) that includes the S-SG and an identifier of one service included in the S-SG, establishing a layer three signaling connection and exchanging messages related to the one service identified in the S-TMSI, wherein the energy indicates a page message, the S-SG is initially set equal to Pr-SG; and
a processor, coupled to the memory, configured to execute the instructions retained in the memory.

28. The wireless communications apparatus of claim 27, wherein the memory further retains instructions related to bitwise ANDing Multi-Service bits in the B-TMSI with services enabled in the Pr-SG to obtain a first result, bitwise ORing the retransmission status bits in the B-TMSI with the S-SG to obtain a second result, and bitwise ANDing the first result with the second result to calculate the secondary services group.

29. The wireless communications apparatus of claim 27, wherein the B-PI does not contain energy if the paging message is not a broadcast message.

30. The wireless communications apparatus of claim 27, wherein the memory further retains instructions related to decoding one or more broadcast messages carried on shared channels in connected mode after successfully decoding the Broadcast Paging Indicator.

31. A wireless communications apparatus that receives a multiple location based-services page transmitted to a plurality of users, comprising:
means for storing a Primary Temporary Mobile Station Identity (Pr-TMSI);
means for detecting energy on a Broadcast Paging Indicator (B-PI), wherein the energy indicates a page message;
means for decoding a Broadcast TMSI (B-TMSI) included in the page message, the B-TMSI comprises retransmission status bits and a group of services that indicates one or more services are available;
means for generating a Primary Services Group (Pr-SG) as a function of a first portion of the Pr-TMSI and services enabled;
means for iteratively evaluating a secondary Services Group (S-SG) as a function of the Pr-SG, the group of services, the retransmission status bits, and a highest priority service received for a first time, wherein S-SG is initially set equal to Pr-SG;
means for transmitting a Secondary TMSI (S-TMSI) that includes the S-SG and an identifier of one service included in the S-SG; and
means for receiving messages related to the service identified in the S-TMSI.

32. The wireless communications apparatus of claim 31, further comprising:
means for bitwise ANDing Multi-Service bits in the B-TMSI with services enabled in the Pr-SG to obtain a first result;
means for bitwise ORing the retransmission status bits in the B-TMSI with the S-SG to obtain a second result; and
means for bitwise ANDing the first result with the second result to calculate the secondary services group.

33. The wireless communications apparatus of claim 31, further comprising means for updating a Primary Services Group (Pr-SG) if at least one service is enabled and energy is detected on the Broadcast Paging Indicator.

34. A computer program product, comprising:
a computer-readable medium comprising:
a first set of codes for causing a computer to store a Primary Temporary Mobile Station Identity (Pr-TMSI);
a second set of codes for causing the computer to detect energy on a Broadcast Paging Indicator (B-PI), wherein the energy indicates a page message;
a third set of codes for causing the computer to decode a Broadcast TMSI (B-TMSI) included in the page message, the B-TMSI comprises retransmission status bits and a group of services that indicates one or more services are available;
a fourth set of codes for causing the computer to generate a Primary Services Group (Pr-SG) as a function of a first portion of the Pr-TMSI and services enabled;
a fifth set of codes for causing the computer to iteratively determine a secondary Services Group (S-SG) as a function of the Pr-SG, the group of services, the retransmission status bits, and a highest priority service received for a first time, wherein S-SG is initially set equal to Pr-SG;
a sixth set of codes for causing the computer to transmit a Secondary TMSI (S-TMSI) that includes the S-SG and an identifier of one service included in the S-SG; and
a seventh set of codes for causing the computer to receive messages related to the service identified in the S-TMSI.

35. At least one processor configured to receive a multiple location based-services page, comprising:
a first module for retaining a Primary Temporary Mobile Station Identity (Pr-TMSI);
a second module for detecting energy on a Broadcast Paging Indicator (B-PI), wherein the energy indicates a page message;
a third module for decoding a Broadcast TMSI (B-TMSI) included in the page message, the B-TMSI comprises retransmission status bits and a group of services that indicates one or more services are available;
a fourth module for ascertaining a Primary Services Group (Pr-SG) as a function of a first portion of the Pr-TMSI and services enabled;
a fifth module for iteratively determining a secondary Services Group (S-SG) as a function of the Pr-SG, the group of services, the retransmission status bits, and a highest priority service received for a first time, wherein S-SG is initially set equal to Pr-SG;
a sixth module for conveying a Secondary TMSI (S-TMSI) that includes the S-SG and an identifier of one service included in the S-SG;
a seventh module for establishing a layer three signaling connection; and
an eighth module for exchanging messages related to the one service identified in the S-TMSI.
